(19) United States
(12) Patent Application Publication
(10) Pub. No.: US 2014/0089077 A1
(43) Pub. Date: Mar. 27, 2014

(54) CONSUMER OPERATED KIOSKS FOR PURCHASING FRESH FOODS AND ASSOCIATED SYSTEMS AND METHODS

(71) Applicant: COINSTAR, INC., Bellevue, WA (US)

(72) Inventors: Scott Lee Zuckerman, Deerfield, IL (US); Alex Aziz Doumani, Portland, OR (US); Nicole Marie Roden, Chicago, IL (US)

(73) Assignee: COINSTAR, INC., Bellevue, WA (US)

(21) Appl. No.: 13/802,070

(22) Filed: Mar. 13, 2013

Related U.S. Application Data
(60) Provisional application No. 61/704,294, filed on Sep. 21, 2012.
(60) Provisional application No. 61/733,054, filed on Dec. 4, 2012.

(51) Int. Cl. G06Q 30/06

(52) U.S. Cl. CPC G06Q 30/0643
USPC 705/14.37; 705/27.2; 705/26.8

(57) ABSTRACT

The present disclosure is directed to consumer operated kiosks for purchasing fresh foods and associated systems and methods. In one embodiment, for example, a consumer operated kiosk can include a temperature controlled compartment for storing an inventory of fresh foods items, a user interface configured to receive user instructions corresponding to selected fresh food items, and a product retrieval system configured to move selected fresh food items from the temperature controlled compartment to a dispensing area. In various embodiments, the consumer operated kiosk can further include a communications facility configured to send transaction information associated with fresh food items purchased at the consumer operated kiosk to a remote computer, and the remote computer can update associated inventory information and store it in a remote database. The remote computer can monitor ages of the fresh food items in the inventory.

### CROSS REFERENCE TO RELATED APPLICATIONS

This application claims the benefit of and priority to U.S. Provisional Patent Application No. 61/733,054, filed Dec. 4, 2012, and U.S. Provisional Patent Application No. 61/704,294, filed Sep. 21, 2012, each of which is incorporated herein by reference in its entirety

### TECHNICAL FIELD

The present disclosure relates generally to consumer operated kiosks and, more particularly, to consumer operated kiosks for purchasing fresh foods and associated systems and methods.

### BACKGROUND

Vending machines automatically dispense various items to consumers after receiving payment (e.g., currency or credit). Many vending machines, for example, dispense prepackaged snacks (e.g., potato chips, candy bars, etc.) and beverages (e.g., soda, water, etc.) and, therefore, provide convenient mechanisms for purchasing foods on the go. Most of the food products dispensed from vending machines have long shelf lives to reduce maintenance and costs associated with restocking perished items. This criterion, however, limits the types of foods available for purchase in vending machines.

### BRIEF DESCRIPTION OF THE DRAWINGS

FIG. 1A is an isometric view of a consumer operated kiosk for purchasing fresh foods configured in accordance with embodiments of the present disclosure.

FIG. 1B is an isometric view illustrating devices housed within the consumer operated kiosk of FIG. 1A.

FIGS. 1C and 1D are isometric views illustrating features of a refrigerated compartment of the consumer operated kiosk of FIG. 1A.

FIG. 2A is an isometric view of a shelving assembly of the consumer operated kiosk of FIGS. 1A-1D configured in accordance with embodiments of the present disclosure.

FIG. 2B is an enlarged isometric view illustrating attachment features of the shelving assembly of FIG. 2A.

FIGS. 3A and 3B are isometric views of shelf units of the shelving assembly of FIG. 2A configured in accordance with embodiments of the present disclosure.

FIGS. 3C and 3D are isometric views of the shelf units of FIGS. 3A and 3B, respectively, loaded with packaged fresh food items.

FIGS. 3E-3G illustrate various features of a driving mechanism of the shelf units of FIGS. 3A and 3B configured in accordance with embodiments of the present disclosure.

FIG. 4A illustrates a product retrieval assembly on the interior of a door of the consumer operated kiosk of FIGS. 1A-1D configured in accordance with embodiments of the present disclosure.

FIGS. 4B and 4C are enlarged front isometric views of a product delivery device in a closed position and an open position, respectively, configured in accordance with embodiments of the present disclosure.

FIG. 4D is an enlarged front isometric view of a dispensing area of the consumer operated kiosk of FIGS. 1A-1D configured in accordance with embodiments of the present disclosure.

FIGS. 4E and 4F are back isometric views of the product delivery device of FIGS. 4B and 4C in a consumer operated kiosk in accordance with embodiments of the present disclosure.

FIGS. 5A-5E illustrate display pages for purchasing fresh foods from a consumer-operated kiosk in accordance with embodiments of the present disclosure.

FIG. 6 illustrates a suitable network environment for implementing various aspects of a kiosk-based fresh food purchasing system in accordance with embodiments of the present disclosure.

FIGS. 7A and 7B are isometric and front views, respectively, of a consumer operated fresh food kiosk configured in accordance with other embodiments of the present disclosure.

### DETAILED DESCRIPTION

The present disclosure describes various embodiments of consumer operated kiosks and associated systems and methods for purchasing fresh foods. Consumer operated kiosks configured in accordance with several embodiments of the present disclosure can include a temperature controlled compartment that holds fresh food items (e.g., sandwiches, wraps, salads, breakfast items, ready to heat foods, etc.) available for purchase by consumers. In various embodiments, a user can deposit funds (e.g., cash, coins, credit/debit card, etc.) into the kiosk, select the fresh food item(s) the user would like purchase, and the kiosk can dispense the selected fresh food item(s) to the user via a dispensing area accessible to the user. The term “fresh food,” as used herein, can include at least one of the following: foods and beverages that perish within a relatively short period of time after being placed in the kiosk (e.g., 1 day, 2 days, 5 days, 10 days, etc.); foods and beverages that are prepared within a predetermined period of time before being placed in the kiosk (e.g., 1 day, 2 days, 5 days, 10 days, etc.); foods and beverages that must be refrigerated to prevent spoiling; and/or other types of foods and beverages that may be considered “fresh.” Fresh foods can include foods and beverages typically purchased from, for example, a refrigerated case in a coffee shop, sandwich shop, and/or the deli section of a grocery store (e.g., prepackaged sandwiches, salads, wraps, burritos, cheeses, fruits, smoothies, yogurts, etc.), as compared to prepackaged foods having relatively long shelf lives as typically found in, for example, conventional vending machines and convenience stores.

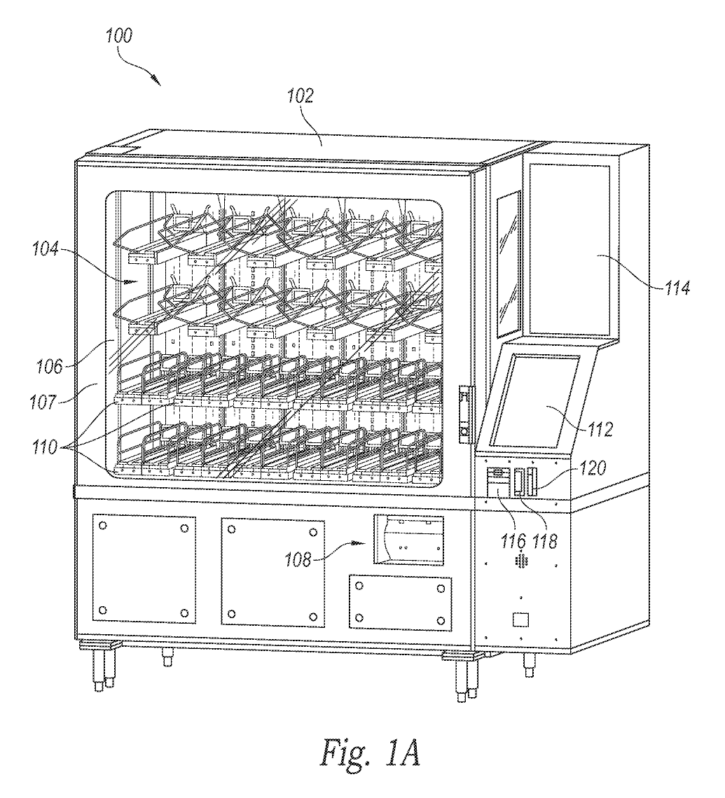

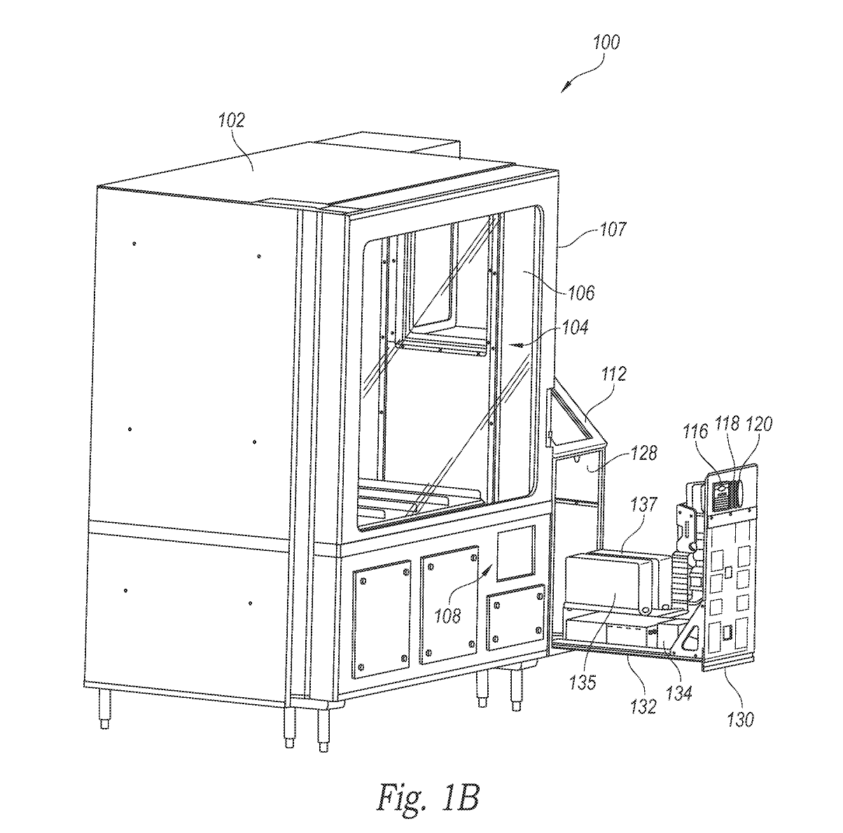

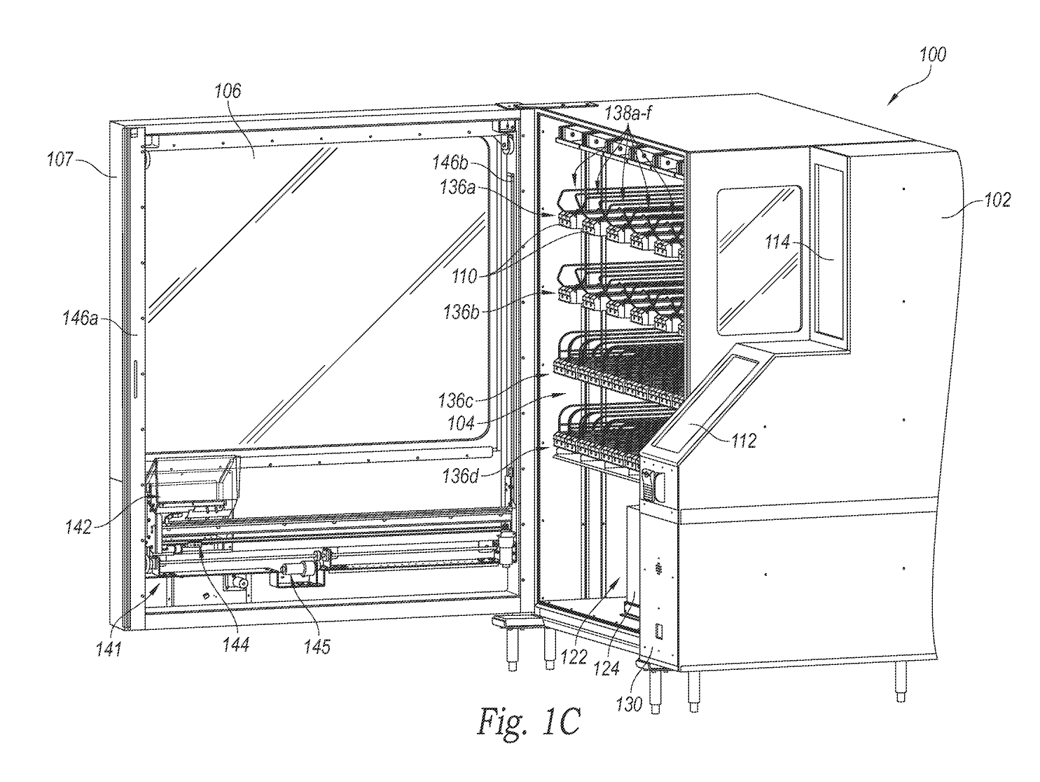

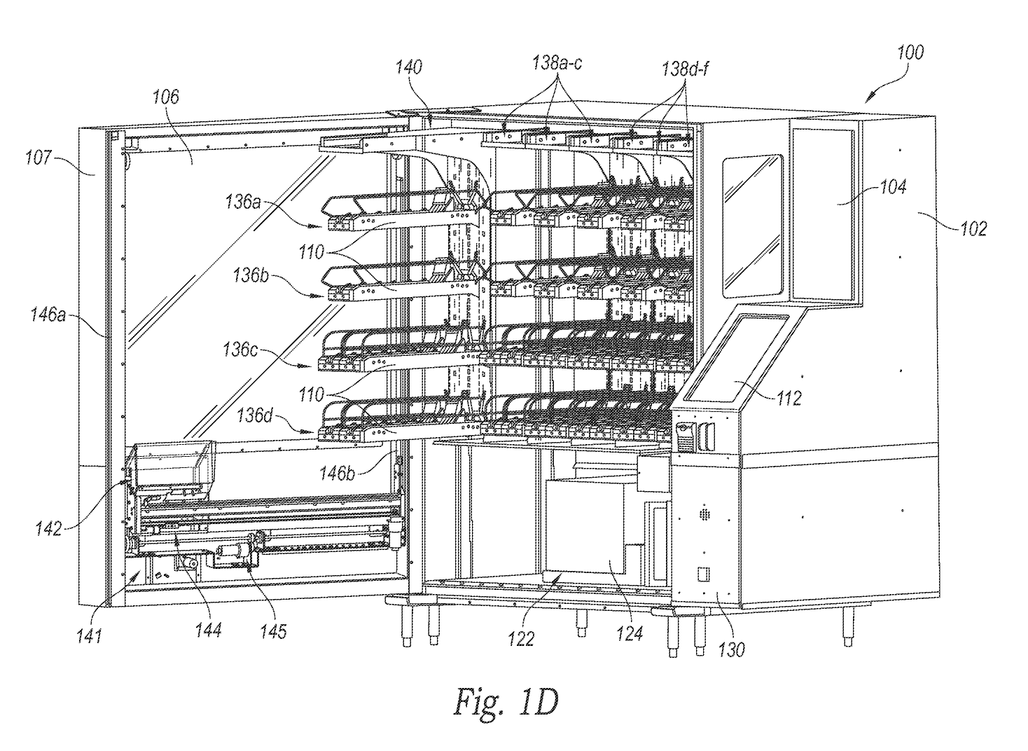

Certain details are set forth in the following description and in FIGS. 1A-7B to provide a thorough understanding of various embodiments of the disclosure. Other well-known structures and systems often associated with consumer operated kiosks, food storage, and related commerce systems have not been shown or described in detail below to avoid unnecessarily obscuring the descriptions of the various embodiments of the disclosure. Additionally, a person of ordinary skill in the relevant art will understand that the disclosure may have additional embodiments that may be practiced without several of the details described below. In other instances, those of ordinary skill in the relevant art will appreciate that the methods and systems described can include additional details without departing from the spirit or scope of the disclosed embodiments.

Many of the details, dimensions, functions and other features shown and described in conjunction with the Figures are merely illustrative of particular embodiments of the disclosure. Accordingly, other embodiments can have other details, dimensions, functions and features without departing from the spirit or scope of the present disclosure. In addition, those of ordinary skill in the art will appreciate that further embodiments of the disclosure can be practiced without several of the details described below.

FIGS. 1A-1D are isometric views of a consumer operated kiosk 100 (“kiosk 100”) for purchasing fresh foods configured in accordance with embodiments of the disclosure. The kiosk 100 can include a housing 102, a temperature controlled or refrigerated food storage area or compartment 104 within the housing 102, a display window 106 positioned on a door 107 at a front side of the housing 102, and a dispensing area 108 in communication with the refrigerated compartment 104. As shown in FIG. 1A, the refrigerated compartment 104 can include a plurality of shelf units 110 configured to hold fresh food items. The display window 106 can be at least partially transparent and positioned in front of the shelf units 110 to allow consumers to view the fresh food items available for purchase at the kiosk 100. The kiosk 100 can include various mechanisms for receiving payment from consumers, including a bill and coin acceptor 116, a card reader 120 (e.g., a magnetic card swipe), and/or other types of payment mechanisms. After the kiosk 100 has received payment for a selected fresh food item, a product retrieval system 141 (FIG. 1C) within the refrigerated compartment 104 can move the selected food item from a specified shelf unit 110 to the dispensing area 108 where the consumer can retrieve the selected food item.

As shown in FIGS. 1A and 1B, the kiosk 100 can further include a user interface 112 and/or a display 114 for providing information to users. The user interface 112 can include a screen or monitor for operationally interfacing with users via visual and/or audible signals, textual instructions, animations, dialogue boxes, touch screens, selector buttons, icons, prompts, and/or other features provided and/or displayed to users. In the illustrated embodiment, for example, the user interface 112 includes a touch screen that can be configured to receive user selections related to the food items available for purchase at the kiosk 100 and provide users with information related to the food items (e.g., price, nutritional information, ingredients, etc.). In other embodiments, the user interface 112 can include other input devices that can provide and/or receive user information, such as a keyboard, an encrypted PIN pad, a voice command device, and/or other suitable user input devices known in the art. The display 114 can include a screen or monitor that can provide users with various types of digital information at the point of sale. For example, the display 114 can provide consumers with instructions on how to operate the kiosk 100 (e.g., how to purchase fresh food items from the kiosk 100), information about the food items for sale at the kiosk 100 (e.g., menus, nutritional information, etc.), and/or marketing information associated with the food items for sale at the kiosk 100 (e.g., promotions, advertisements, etc.). In other embodiments, the display 114 can include a transparent case or other designated area in which printed materials (e.g., advertisements, menus, nutritional information, etc.) can be physically displayed at the point of sale.

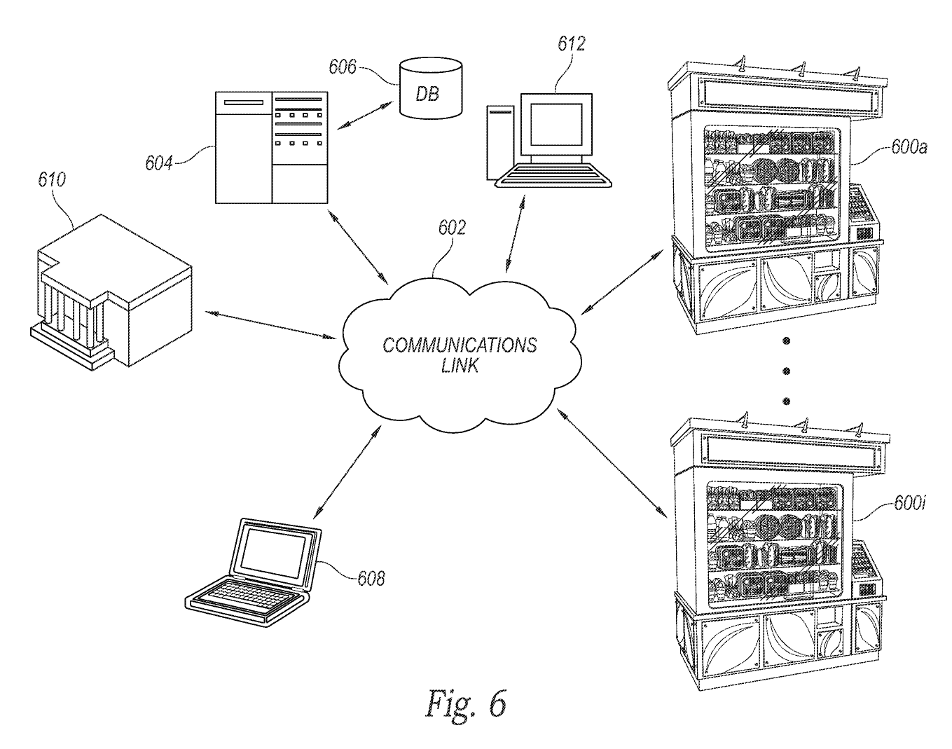

In certain aspects of the technology, the kiosk 100 can be operably coupled to a communications link (e.g., the Internet, LAN, intranet, etc.) via a wired or wireless connection. The communications link allows the kiosk 100 to communicate with and transfer information to and from a remote database (not shown) and/or other consumer operated kiosks in the same network. As described in further detail below with reference to FIG. 6, the communications link also enables the kiosk 100 to exchange information (e.g., upload and download) with one or more remote computers, such as a remote computer located at a central facility for managing the operations and/or maintenance of a plurality of consumer operated kiosks like the kiosk 100 shown in FIG. 1A. The remote computer can run routine maintenance checks on the kiosk 100 to identify mechanical problems (e.g., temperature variations within the refrigerated compartment 104) and/or glitches in the user interface 112 and/or the display 114.

In various embodiments, the kiosk 100 can communicate with the remote computer or remote computers to provide information related to the kiosk inventory. The remote computer, for example, can be used to determine when the kiosk 100 needs to be restocked, indicate when the fresh food items in the inventory are nearing a predetermined age (e.g., a sell-by date, “enjoy by” date, expiration date, etc.), and/or manage other information associated with the kiosk inventory. For example, when the kiosk 100 is stocked with the new food item, a maintenance technician can indicate that the item has been placed in the kiosk 100 (e.g., using the user interface 112 or a remote device), and the remote computer can communicate with the kiosk 100 to download new item to the menu of items available for purchase at the kiosk 100. The remote computer can also identify when an item is sold out at the kiosk or should otherwise be made unavailable (e.g., due to product recalls, expiration dates, etc.), and communicate with the kiosk 100 to remove the item from the kiosk's menu. In other embodiments, the remote computer can provide the kiosk 100 with instructions to display messages (e.g., “sold out”, “not available”, etc.) associated with the individual menu items to indicate to consumers that the corresponding food item is no longer available for purchase at the kiosk 100 (e.g., the food item is sold out, past a predetermined age, etc.). The remote computer can also retrieve data from the kiosk 100 related to transactions surrounding the sale of a product, including the specific food products sold, the time of transaction, the total amount spent, the method of payment, consumer information (e.g., from a user account associated with the kiosk 100), and/or other suitable types of information. This information can be used to analyze kiosk trends and patterns, such as consumer demand on certain food items (e.g., time of day, day of week, type of food). Additionally, the remote computer or an associated database can store information related to pricing, menu selections, nutrition, and/or other information provided to consumers via the user interface 112 and/or the display 114. This allows the information to be updated and added at a central facility and uploaded to a plurality of kiosks in the same network. In various embodiments, the communications link also enables users to preview, pre-select and/or reserve food items for purchase at the kiosk 100 from a personal computer, handheld device, etc. Order information related to the pre-selected food items can be saved to a remote database and communicated to the kiosk 100 upon receipt of user identification information (e.g., user account login information, credit card information, etc.) associated with the order. In certain embodiments, the remote computer can also communicate with the kiosk 100 to monitor the funds received and dispensed by the kiosk 100. Various aspects of the communications link and suitable network systems for the kiosk 100 are described in further detail below with respect to FIG. 6.

As shown in FIG. 1B, the housing 102 can include a compartment 128 that stores various electronic and electromechanical devices associated with the kiosk 100. In the illustrated embodiment, the compartment 128 is positioned behind a panel 130 of the housing 102 beneath the user interface 112, but in other embodiments, the compartment 128 can be positioned elsewhere on or within the kiosk housing 102, or may be one of a plurality of storage compartments within the kiosk housing 102. The compartment 128 can be accessed by pulling the panel 130 away from the kiosk housing 102 and sliding, rolling, or otherwise moving a drawer or tray 132 attached to the panel 130 out from the compartment 128. In other embodiments, the compartment 128 can be accessed using other suitable mechanisms. The panel 130, for example, can be hingedly coupled to the body of the housing 102 and opened like a door to access the compartment 128. In the illustrated embodiment, the compartment 128 includes a mechanical locking system 118 that allows the compartment 128 to be locked (e.g., using a key) when in a vending arrangement and accessible only by an operator and/or other authorized personnel when in an operator arrangement for maintenance and repair of the internal features of the kiosk 100. In other embodiments, the compartment 128 can be locked using other types of locking mechanisms, such as a card key (e.g., swiped through the card reader 120), a code (e.g., entered via the user interface 112), a biometric identifier (e.g., a fingerprint scanner), etc.

As shown in FIG. 1B, the payment devices (e.g., the card reader 120, bill acceptor 116, etc.) can be mounted on the panel 130 and/or carried by the tray 132. The tray 132 can also carry various electrical devices including, for example, a controller 134 (e.g., a computer), a power supply 135, and a communications facility 137 (e.g., a router, modem, other wireless communication device, etc.) that operably couples the kiosk 100 to a communications link (e.g., the Internet, LAN, intranet, etc.; described in greater detail below with reference to FIG. 6). As described in further detail below, the controller 134 can be configured to receive information from and provide instructions to various features of the kiosk 100, and the communications facility 137 can allow the kiosk 100 to wirelessly communicate with various remote computers (e.g., computers at a central processing facility, host computers, etc.), remote databases, financial institutions, other consumer operated kiosks within the same network, and/or other remote computer systems to perform various notification and transaction functions.

As shown in FIGS. 1C and 1D, the refrigerated compartment 104 can be accessed by opening the door 107 of the housing 102. Similar to the side compartment 128 described above with reference to FIG. 1B, the refrigerated compartment 104 is only accessible to kiosk operators (e.g., by unlocking the door 107 with a card, key, or code). In the illustrated embodiment, the door 107 extends across the front face of the kiosk 100. In other embodiments, however, the kiosk 100 can include two or more doors that provide access to smaller sections of the refrigerated compartment 104. The door 107 provides convenient access from the front side of the kiosk 100 for restocking the refrigerated compartment 104 and/or other maintenance performed by the kiosk operator.

When the door 107 is closed (e.g., as shown in FIGS. 1A and 1B), the refrigerated compartment 104 can be fully or partially sealed and insulated from the external environment to maintain a cool temperature and provide balanced airflow through the compartment 104. As shown in FIGS. 1C and 1D, the kiosk 100 can include a refrigeration unit or system 122 positioned below the refrigerated compartment 104 and separated therefrom by a dividing wall or other type of enclosure 124 (e.g., a sheet metal enclosure). The refrigeration system 122 includes a condenser section, an evaporator section, and other features associated with conventional refrigeration systems. In certain embodiments, the evaporation section exhaust can be ducted along a back wall of the kiosk housing 102 and into the refrigerated compartment 104 through vents (e.g., openings or holes) to allow for substantially even cooling of the refrigerated compartment 104. An inlet to the condenser section can be placed in communication with the refrigerated compartment 104 (e.g., positioned at the bottom of the refrigerated compartment 104) and ducted through a filter into the refrigeration system 122, and the exhaust from the condenser section can be vented from the back of the kiosk 100. In other embodiments, the refrigeration system 122 can have other suitable configurations and features typically associated with refrigeration systems.

The refrigerated compartment 104 can define a single temperature controlled area or zone cooled by the refrigeration system 122. The temperature controlled zone can maintain a temperature between, for example, approximately 32-41° F. (0-5° C.). In other embodiments, the temperature range can be larger (e.g., 30-45° F. (−1.1-7.2° C.)), narrower 35-40° F. (1.7-4.4° F.), higher and/or lower depending upon the types of foods stored in the refrigerated compartment 104. In further embodiments, the refrigerated compartment 104 can include a plurality of temperature controlled zones, with each zone insulated from the others and capable of maintaining a separate temperature profile suitable for certain types of food products. The refrigerated compartment 104, for example, can include a first temperature controlled zone for storing food products that should be stored in a substantially frozen state (e.g., smoothies) and a second temperature controlled zone for storing food products at higher temperatures relative to the first zone.

In various aspects of the technology, the kiosk 100 can include one or more temperature sensors (not shown) positioned within the refrigerated compartment 104 and communicatively coupled to the controller 134 (FIG. 1B) and/or a remote computer, which can send messages or alerts to the system operator when the temperature measured in refrigerated compartment 104 exceeds a temperature threshold (e.g., 45° F. (7.2° C.)). If the temperature remains above or below the threshold temperature for a predefined time period (e.g., the time it would take for the food items to begin to spoil, more than five minutes, more than 10 minutes, conform to regulatory standards, etc.), the controller 134 or remote computer can be configured to disable the kiosk 100 from further use by consumers. In certain embodiments, the controller 134 can be configured to distinguish between improper increases in temperature and increases caused by maintenance activities (e.g., when the door 107 is open). The controller 134, for example, can determine (e.g., via a sensor) when the door 107 of the kiosk 100 has been opened, and if the opening of the door 107 was a result of a mechanical issue or in response to maintenance personnel opening the door (e.g., using a key or card to gain access).

The refrigerated compartment 104 includes a plurality of shelf units 110 that can store and display the fresh food items in the display window 106. The shelf units 110 can be arranged in a plurality of rows (identified individually as first through fourth rows 136a-d, respectively, and referred to collectively as rows 136) and columns (identified individually as first through sixth columns 138a-f, respectively, and referred to collectively as columns 138). As shown in FIGS. 1C and 1D, the refrigerated compartment 104 includes four rows 136 and six columns 138 of shelf units 110. In other embodiments, shelf units 110 can be arranged in another suitable configuration of rows 136 and/or columns 138.

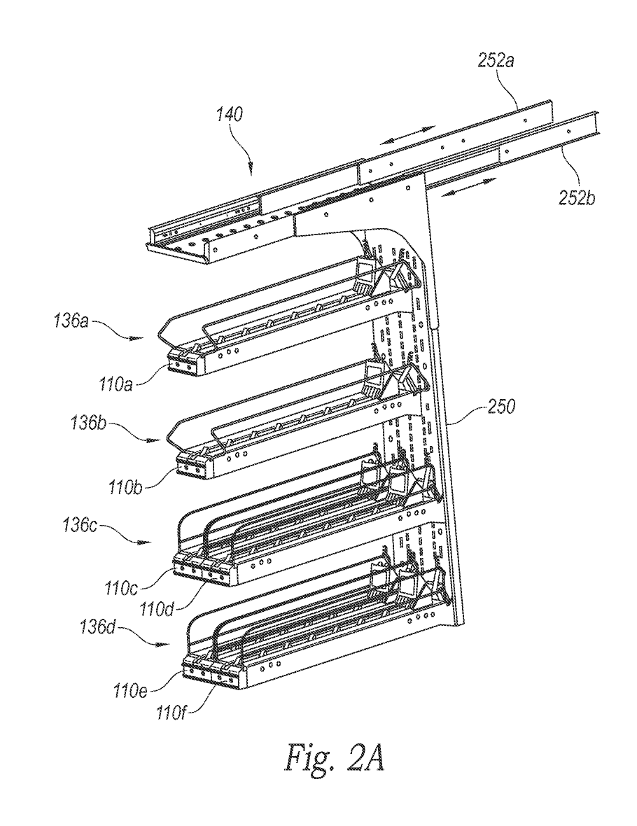

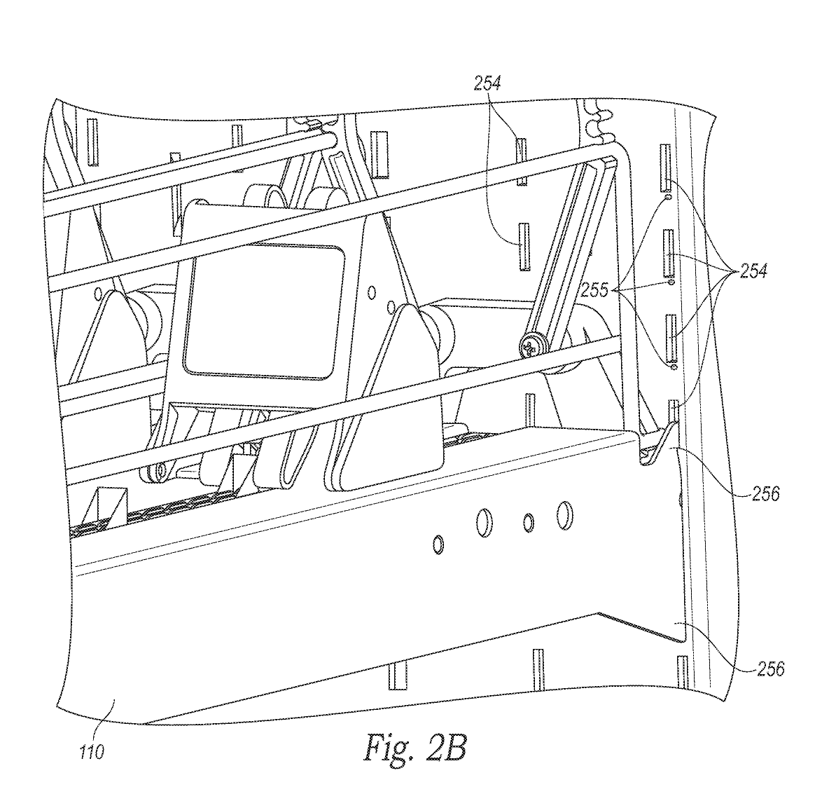

Referring to FIG. 1D, the shelf units 110 of each column 138 can be part of a shelving assembly 140 that can automatically and/or manually move from a loaded position (e.g., the second through sixth columns 138b-f) to a loading position (e.g., the first column 138a). As described in further detail below with respect to FIG. 2A, each column 138 of shelf units 110 can slide or roll along rails to move the shelf units 110 at least partially outside of the refrigerated compartment 104, and thereby facilitate access to the shelf units 110 for restocking and maintenance. In other embodiments, the shelving assemblies 140 and/or shelf units 110 can be moved into and out of the refrigerated compartment 104 for restocking using other suitable configurations.

When the shelf units 110 are stocked with fresh food items and moved into the loaded position within the refrigerated compartment 104, the door 107 of the kiosk housing 102 can be closed (e.g., as shown in FIGS. 1A and 1B), and the product retrieval system 141 can be used to automatically retrieve selected food items from specified shelf units 110 and deliver the selected food items to the dispensing area 108 (FIGS. 1A and 1B). As shown in FIGS. 1C and 1D, the product retrieval system 141 can be positioned on the inside of the kiosk door 107. The product retrieval system 141 can include a product delivery device 142 movably mounted to a first or horizontal rail assembly 144, which is in turn movably coupled to a second or vertical rail assembly (identified individually as a first vertical rail 146a and a second vertical rail 146b, and referred to collectively as the vertical rail assembly 146) extending vertically along the interior sides of the door 107. As described in further detail below, the product retrieval system 141 can be coupled to one or more motors 145 (e.g., a stepper motor) that move the product delivery device 142 (e.g., via instructions from the controller 134 (FIG. 1B)) horizontally along the first rail assembly 144 to align the product delivery device 142 with the column 138 of a selected food item, and move the first rail assembly 144 vertically along the second rail assembly 146 to align the product delivery device 142 with the row 136 of the selected product. For example, the product retrieval system 141 can use an x-y coordinate system to navigate to and retrieve products from predefined positions within the refrigerated compartment 104 (i.e., identified by the row 136 and column 138 of a selected product).

Once the product delivery device 142 is positioned at the appropriate shelf unit 110, the shelf unit 110 can move the selected product forward until it falls off the shelf unit 110 into the product delivery device 142. Because the product delivery device 142 is positioned very near the edge of the shelf unit 110, the product packaging and the food stored therein is not expected to incur damage as the product moves from the shelf unit 110 to the product delivery device 142. In other embodiments, the product delivery device 142 can include a robotic arm or other mechanism that can retrieve the selected product from the shelf unit 110. After receiving the selected product, the product delivery device 142 can move along the horizontal and vertical rails 144 and 146 to the dispensing area 108 where a consumer can retrieve the selected product. In other embodiments, the kiosk 100 can use other automated retrieval mechanisms suitable for moving fresh food products from the shelf units 110 to the dispensing area.

Embodiments of the kiosk 100 are configured to provide an automated system for purchasing fresh foods (e.g., sandwiches, salads, wraps, etc.). A consumer can browse the fresh food options available for purchase at the kiosk 100 by viewing the fresh food products through the display window 106 and/or viewing a menu of the fresh food products on the user interface 112 and/or the display 114. The user interface 112 and/or the display 114 can provide consumers with information related to the food items within the kiosk 100, such as nutritional information, pricing, descriptions of the food items, and/or advertisements. When the consumer is ready to make a purchase, the consumer can select the food item he or she would like to purchase via the user interface 112, and place funds (e.g., currency, coins, or credit) into the kiosk 100 using the bill and coin acceptor 116 and/or the card reader 120. In various embodiments, the consumer can select more than one food item during a single transaction by placing it into a virtual shopping cart (described in greater detail below), and pay for a plurality of selected food items at one time (e.g., before or after selecting the food items). After payment has been received, the kiosk 100, via instructions from the controller 134 (FIG. 1B), can then instruct the product delivery device 142 to the retrieve the selected food item from its predefined position within the refrigerated compartment 104 and deliver the selected food item to the dispensing area 108, from which the consumer can retrieve the selected food item.

In certain aspects of the technology, the kiosk 100 is able to receive payment from the consumer at any time during the transaction. The consumer can, for example, deposit funds into the bill acceptor 116 and/or the card reader 120 before selecting a food item, and the kiosk 100 can apply the received funds toward the total cost of the selected food item(s) upon check out. In some embodiments, the kiosk 100 can display, via the user interface 112, a running total of the consumer's available funds, decrementing an amount from the total each time the consumer selects another item. Alternatively, the kiosk 100 can display a running tab of the total cost of the transaction. When the consumer has finished selecting items, the consumer can press a checkout button on the user interface 112 or otherwise indicate to the kiosk 100 that the consumer is ready to check out. If the consumer has not deposited enough funds to pay for the selected item(s), the kiosk 100 can request (e.g., via the user interface 112) that the consumer deposit additional funds and wait until the requisite funds are deposited before dispensing the selected item(s) to the consumer. If the consumer has deposited extra funds, the kiosk 100 can dispense the difference between the purchase price and the received funds to the consumer (e.g., via the bill and coin acceptor 116) or save the funds to a user account created by the consumer for later use by the consumer at the kiosk 100 or a kiosk within the same network. The kiosk 100 can also accept payment at the end of the transaction, after the consumer has finished selecting food items, and wait until payment has been received before dispensing the selected food item(s). The kiosk's ability to accept payment at any time during the transaction provides consumers with additional flexibility not provided by conventional vending machines that do not allow product selection until payment has been received. In addition, when the kiosk 100 receives multiple item selections during a single transaction, consumers can pay for a plurality of items at one time rather than having to pay for each item in a separate transaction.

In various embodiments, the kiosk 100 can be configured to communicate with a remote computer and/or a remote database via the communications facility 137 to monitor the age of the fresh food items in the kiosk 100. The age can be associated with a packaging, sell-by, and/or expiration date assigned to the individual fresh food items, the length of time the fresh food items have been in the kiosk 100, and/or other temporal aspects affecting the freshness of the food items. When fresh food items are added to the inventory of the kiosk 100, the date on which they are added, the sell-by date, and/or the expiration date of the fresh food items can be communicated to the remote computer, and stored on a remote database. In other embodiments, the inventory and/or age-related information can be stored on a local database at the kiosk 100 (e.g. on the computer/controller 134).

The age-related information can be provided by an operator (e.g., at a central processing facility) based on a delivery/restocking schedule and/or a maintenance technician as the food items are added to the kiosk 100. The information can also be communicated to the remote computer via the kiosk 100 by scanning or otherwise identifying the items as they are added to the kiosk 100 (e.g., reading a bar code), and/or other suitable mechanism for identifying the age of the fresh food products. In certain embodiments, the age-related information is specific to the individual fresh food items in the kiosk 100, and in other embodiments the age-related information applies to the inventory of the kiosk 100 as a whole. The remote computer can use this information to monitor or track the age of the fresh food items in the kiosk inventory to maintain their freshness. When fresh food items are nearing or at a specified age (e.g., a packaging date, a sell-by date, expiration date, predetermined time within the kiosk 100, etc.), the remote computer can communicate with the kiosk 100 to prevent future sale of the items and/or notify the operator that the items need to be removed from the kiosk. The remote computer can also communicate with the kiosk 100 to disable future sales of items for various other reasons. For example, the remote computer can disable future sales of products that are subject to market or safety concerns (e.g., product recalls, exposure to unacceptable temperature ranges, etc.).

FIG. 2A is an enlarged isometric view of the shelving assembly 140 for storing fresh foods in the refrigerated compartment 104 of the kiosk 100 of FIGS. 1A-1D. As described above, the shelving assembly 140 includes a plurality of shelf units 110 (identified individually as first through sixth shelf units 110a-110f, respectively) that can carry various types of prepacked fresh food products. The shelf units 110 can be arranged in a desired configuration and attached to a vertical support member 250. In the illustrated embodiment, for example, the shelving assembly 140 includes four rows 136a-d of shelf units 110, some of the rows 136a, 136b including one shelf unit 110, and other rows 136c, 136d including more than one shelf unit 110. The support member 250 can be slidably attached to one or more horizontal rails (identified individually as a first rail 252a and a second rail 252b, and referred to collectively as rails 252). The rails 252 can be fixedly attached to the housing 102 (FIGS. 1A-1D) of the kiosk 100 in the refrigerated compartment 104 using various types of fasteners (e.g., screws), or the rails 252 can be integrated with the housing 102.

The shelving assembly 140 (i.e., the shelf units 110 and the support member 250) can slide or otherwise move back and forth along the rails 252 (e.g., as indicated by the arrows shown FIG. 2A) to move the shelf units 110 into and out of the refrigerated compartment 104 (FIGS. 1A-1D) when the kiosk door 107 (FIGS. 1A-1D) is open. In other aspects of the technology, the shelf units 110 can be movably or fixedly positioned within the refrigerated compartment 104 (FIGS. 1A-1D) using other suitable attachment mechanisms for supporting shelves.

FIG. 2B is an enlarged view of a portion of the shelving assembly 140 illustrating attachment mechanisms for connecting the shelf units 110 to the support member 250 in accordance with embodiments of the disclosure. The vertical support member 250 can include a plurality of openings or apertures 254 arranged incrementally along the length and width of the support member 250. The openings 254 can be spaced apart by predefined distances to accommodate various specific widths and/or heights of the shelf units 110. Each shelf unit 110 can include one or more clips or hooks 256 that can be removably received in the openings 254 to cantilever the shelf unit 110 on the support member 250. This arrangement allows the shelf units 110 to be removed from the support member 250, and therefore allows the operator to change the layout of the shelf units 110 with respect to the support member 250 to accommodate products with different dimensions. In various embodiments, a light emitting diode (LED) and/or other visible indicator can be positioned at the front side of the shelf units 110 to provide a visual indicator of the orientation of the shelf unit 110 to facilitate installation.

In various aspects of the technology, the support member 250 can include sensors 255 at the openings 254 to detect the locations of the shelf units 110 as they are installed or rearranged. The sensors 255 can be operably coupled to a controller 134 (FIG. 1B) to identify when a shelf unit 110 is added to or removed from the support member 250. For example, the sensors 255 can indicate which openings 254 a newly added shelf unit 110 engages, and this information can be used to determine the position (e.g., in x- and y-coordinates) of the new shelf unit 110 and/or the size and shape of the shelf unit 110. The controller 134 can use this information to map the configuration of the shelf units 110 in the refrigerated compartment 104. This location information can subsequently be communicated to the product delivery device 142 (FIGS. 1C and 1D) such that when a consumer selects a product, the product delivery device 142 can move to the corresponding row and column of the selected product to retrieve and dispense it to the consumer. In other embodiments, the sensors 255 can be located on different portions of the kiosk 100 (e.g., on the shelf units 110 themselves) suitable for automatically detecting the position of the shelf units 110 and arrangement of the shelf units 110. In further embodiments, the positions of the shelf units 110 on the support member 250 can be manually entered into the system and/or the shelf units 110 can be fixed in predefined positions.

In certain aspects of the technology, the kiosk 100 can be configured to communicate the positions of the shelf units 110 to and/or from a remote central computer. For example, the kiosk 100 can communicate the arrangement of the shelves (e.g., automatically identified via the sensors 255 or manually input by an operator) to the remote central computer to allow an operator at the back end to view and evaluate the shelving configuration to determine whether the shelving configuration needs to be changed (e.g., to accommodate additional or different products) and which products the kiosk 100 can accommodate. In other embodiments, an operator can define a shelving layout, known as a planogram, from a remote computer, and the planogram can be downloaded to one or more kiosks 100 in the same network. This allows an operator to create a planogram that can accommodate a specified product inventory and associate the planogram with one or more kiosks 100 in the same network. For example, a planogram can be designed for a group of kiosks that have certain characteristics that benefit from similar shelving layouts, such as kiosks located in similar areas (e.g., office buildings, shopping centers, universities, particular regions, cities, etc.), and the planogram can be downloaded at the specified group of kiosks 100.

After the planogram has been downloaded at the kiosk 100, a maintenance person can access and view the planogram (e.g., via the user interface 112) and arrange the shelf units 110 accordingly. In certain embodiments, the sensors 255 at the openings 254 can communicate with the remote computer and/or the user interface 112 at the kiosk 100 to indicate whether the maintenance person has arranged the shelf units 110 correctly and, optionally, indicate any deviations from the specified planogram (e.g., by highlighting the shelf units 110 in the incorrect position). The kiosk 100 can, accordingly, provide dynamic management of the shelf units 110.

In various embodiments, the planogram provided to the kiosk 100 by the remote computer can also include position data related to the position of each fresh food item within the specified shelving arrangement. For example, each shelf unit 110 of the planogram can be associated with one type of fresh food item (e.g., turkey sandwiches, yogurt parfaits, etc.), and the position of each shelf unit 110 within the shelving layout can correspond to the position data associated with each fresh food item. After the shelving units 110 have been arranged within the refrigerated compartment 104 (FIG. 1A), the product retrieval system 141 (FIG. 1C) can use the downloaded position data to navigate through the refrigerated compartment 104 and retrieve selected food items from their specified position. In other embodiments, the remote computer can also provide the kiosk 100 with vending instructions associated with the position data (e.g., instructions as to how the product retrieval system 141 should move within the kiosk 100 to retrieve each fresh food item).

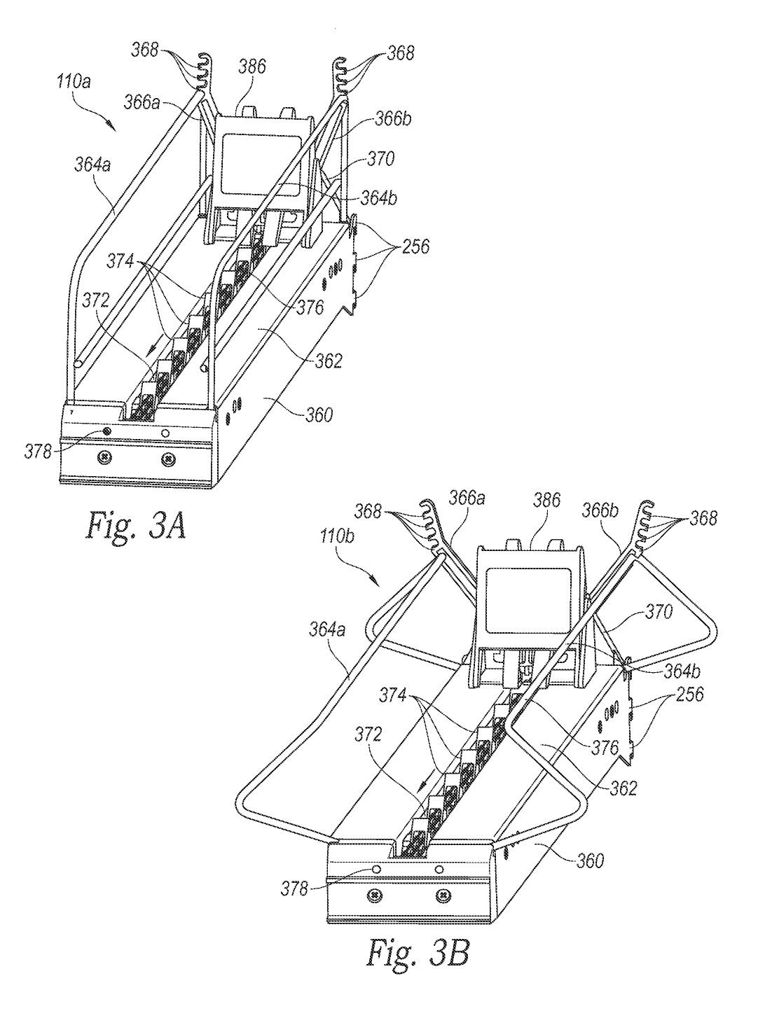

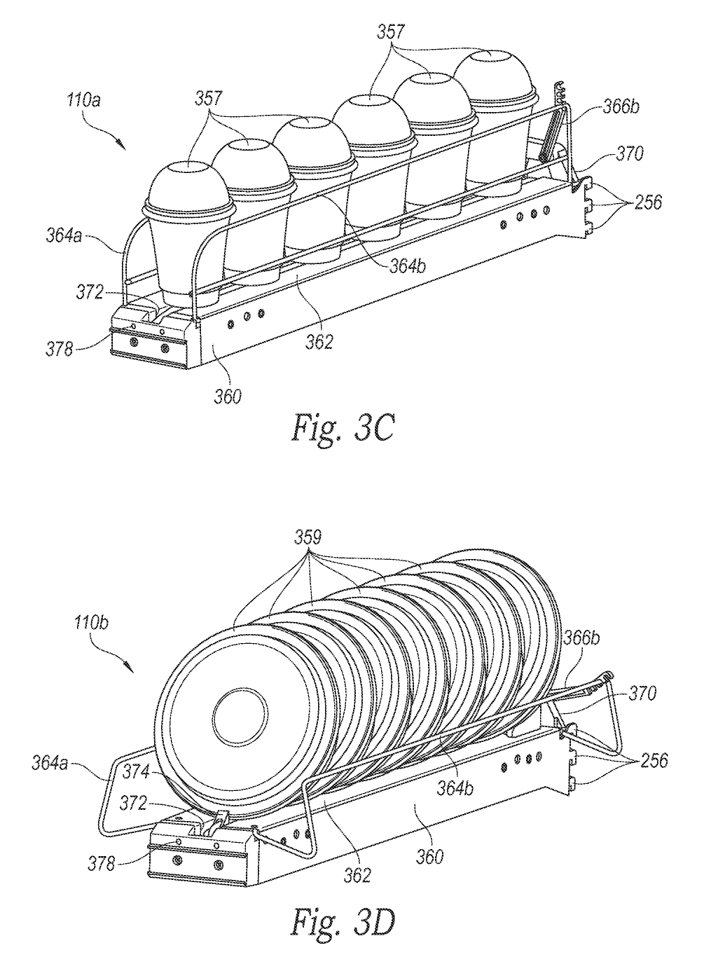

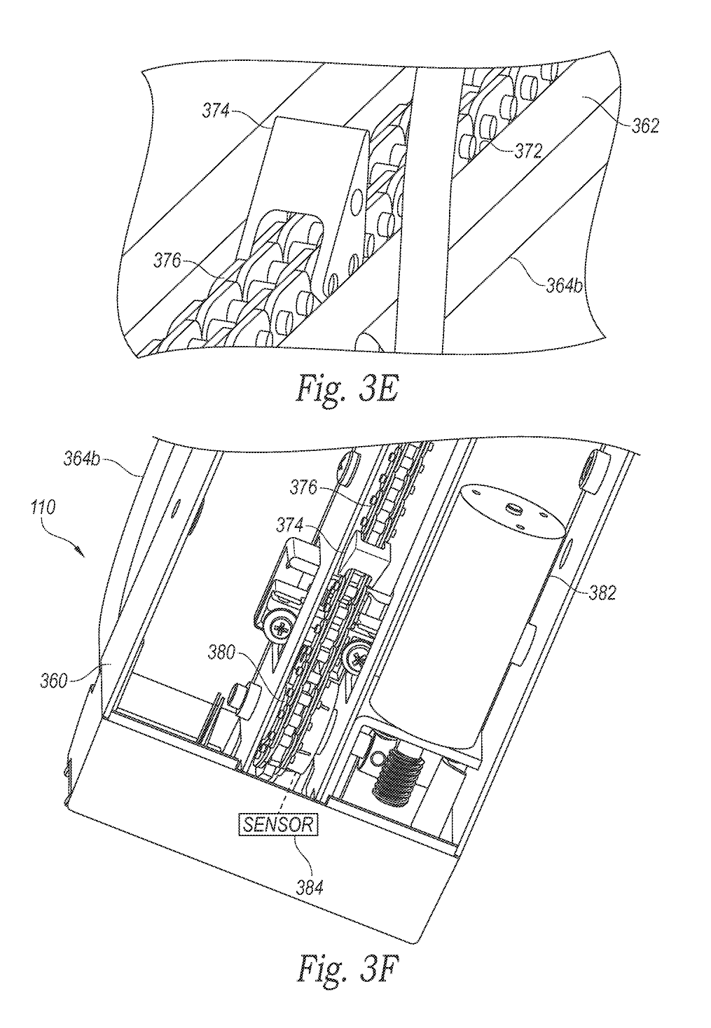

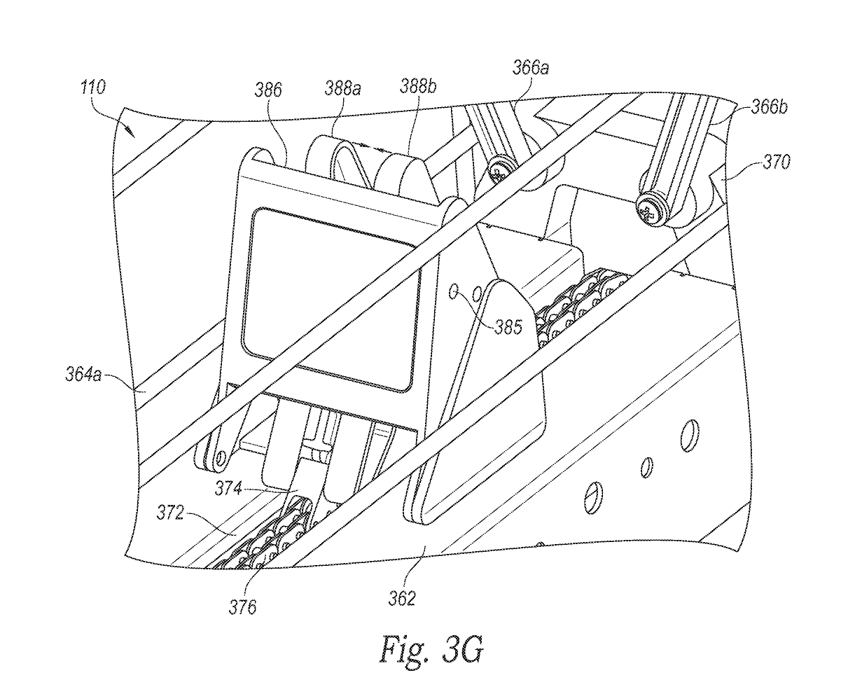

FIGS. 3A and 3B are enlarged isometric views of empty shelf units 110 (identified individually as the first shelf unit 110a and the second shelf unit 110b) of the shelving assembly 140 of FIG. 2A, and FIGS. 3C and 3D are isometric views of the shelf units 110 of FIGS. 3A and 3B, respectively, loaded with packaged fresh food products. FIGS. 3E-3G illustrate various features of the shelf units of FIGS. 3A and 3B. Referring to FIGS. 3A and 3B, the shelf units 110 can include a base portion 360 with a generally planar support surface 362 that can carry various packaged fresh food products. One or more railings or side supports (identified individually as a first side support 364a and a second side support 364b, and referred to collectively as side supports 364) can extend from either side of the base portion 360 to provide lateral support for the packaged food products. In the illustrated embodiments, the first and second side supports 364 are held in position by corresponding first and second support members 366a and 366b (referred to collectively as support members 366). The support members 366 can include a plurality of notches 368 configured to removably receive a portion of the side supports 364, and can be rotatably coupled to a fixture 370 attached to the base portion 360.

The side supports 364 are manually adjustable, and enable the shelf units 110 to accommodate packaged food products of various different geometries and sizes. The side supports 364, for example, can be configured to rotate inwardly toward the support surface 362 (e.g., the configuration shown in FIG. 3A) to support products having generally slender, upright configurations, and rotate outward with respect to the support surface 362 (e.g., the configuration shown in FIG. 3B) to support wider products. The side supports 364 can be fixed in a desired configuration by moving (e.g., rotating) the support members 366 to engage a notch 368 on each support member 366 with a portion of the corresponding side support 364, and securing the support members 366 in a fixed position with respect to the fixture 370 (e.g., by tightening screws that attach the support member 366 to the fixture 370). As shown in FIG. 3C, for example, the side supports 364 of the first shelf unit 110a can be positioned in a substantially vertical orientation suitable for yogurt parfaits 357, beverages (e.g., smoothies), narrow sandwiches (e.g., baguettes), and/or other substantially vertical packages. As shown in FIG. 3D, in other embodiments the side supports 364 can be splayed outward to receive foods packaged in bowls 359 (e.g., salads), rectangular snack boxes, and/or other oddly-shaped packages. The side supports 364 can also include flexible joints that can be shaped to accommodate products with various different geometries and sizes. In other embodiments, the side supports 364 can be fixedly attached to the base portion 360 of the shelf unit 110.

In various aspects of the technology, the shelf units 110 can further include a driving mechanism that moves the packaged food products longitudinally forward along the support surface 362 (i.e., in the direction of the arrows shown in FIGS. 3A and 3B) to deliver selected packaged food products to the product retrieval device 142 (FIGS. 1C and 1D). As shown in FIGS. 3A, 3B and 3E, for example, a plurality of cleats or wedges 374 can be operably coupled to a driver chain 376 positioned under or within the base portion 360 and project through a slit or opening 372 in the support surface 362. The wedges 374 and the drive chain 376 can be made from nylon, other durable polymers, metals, and/or other suitably strong materials. The wedges 374 can be snapped onto or otherwise attached to the chain 376 to define the spacing between products loaded onto the shelf unit 110. In various embodiments, the wedges 374 are detachable from the drive chain 376 to adjust the spacing of the wedges 374 for different product sizes.

In operation, packaged food products can be positioned between two adjacent wedges 374 and, when a consumer selects a product on the shelf unit 110, the wedge 374 positioned behind the product can drive the product forward via the drive chain 376 until the forward-most product on the shelf unit 110 is pushed from the shelf unit 110 into the product retrieval device 142 (FIGS. 1C and 1D). As shown in FIG. 3G, a back support 386 can be connected to the wedges 374 to support taller products. The back support 386 can include a plurality of holes or apertures 385 for detents (not shown) that allow the operator to adjust the angle of the back support 386 to accommodate a variety of different product geometries and sizes. As further shown in FIG. 3G, the back support 386 can also include two levers (identified individually as a first lever 388a and a second lever 388b, and referred to collectively as levers 388) that can be pinched or pressed toward one another (as indicated by the arrows) to release the back support 386 from one wedge 374 and, optionally, attach the back support 386 to a different wedge 374.

FIG. 3F is an isometric view of the underside of the shelf unit 110 illustrating various features of the chain drive system used to move products along the shelf unit 110. As shown in the illustrated embodiment, the chain 376 can be operably coupled to a gear 380 (e.g., a sprocket gear) that meshes with the holes in the chain 376 and rotates (e.g., via power supplied by a motor 382) to drive the chain 376 and the wedges 374 attached thereto along the length of the shelf unit 110. In various aspects of the technology, the chain drive system can include an optical sensor 384 (shown schematically) or other type of sensor that can detect the teeth in the gear 380 to provide the controller 134 (FIG. 1B) with relative position feedback. For example, the controller 134 can use the information from the sensor 384 to rotate the gear 380 a desired degree or number of rotations corresponding to the rotation necessary to move one of the products off the shelf unit 110 (e.g., by moving one of the wedges 374 to the end of the shelf unit 110). In certain embodiments, the shelf units 110 can also include a sensor 378 (e.g., a photo transistor; FIGS. 3A and 3B) at the front of the base portion 360 to ensure the product delivery device 142 (FIGS. 1C and 1D) is in the proper position (e.g., properly aligned with the shelf unit 110) to receive products driven off of the shelf unit 110 before pushing the selected product off of the base portion 360. The positional sensors 378, 384, the gear 380, and other features of the shelf units 110 can be communicatively coupled to the controller 134 (FIG. 1B), the power source 135 (FIG. 1B), and/or other aspects of the kiosk 100 via a cable assembly of power and control lines routed (e.g., in a daisy-chain fashion) on the back of each shelving assembly 140 (FIG. 2A).

In other embodiments, the shelf units 110 can include other drive mechanisms that can move items along the length of the shelf units 110 and deliver them to the product delivery device 142. The shelf units 110, for example, can include conveyer belts for moving products along the shelf units 110.

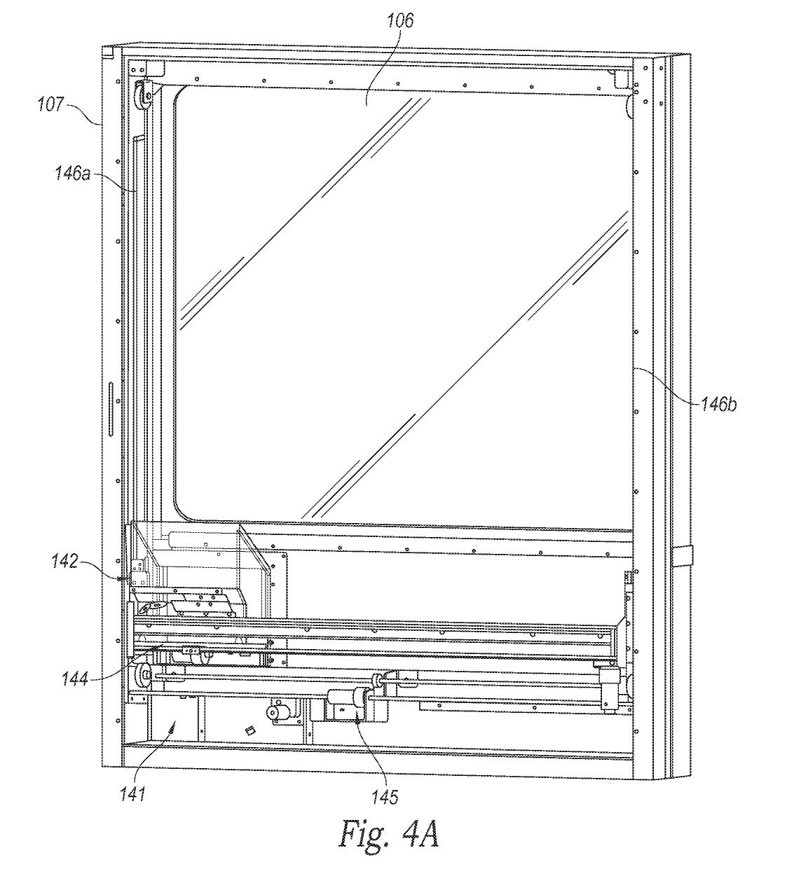

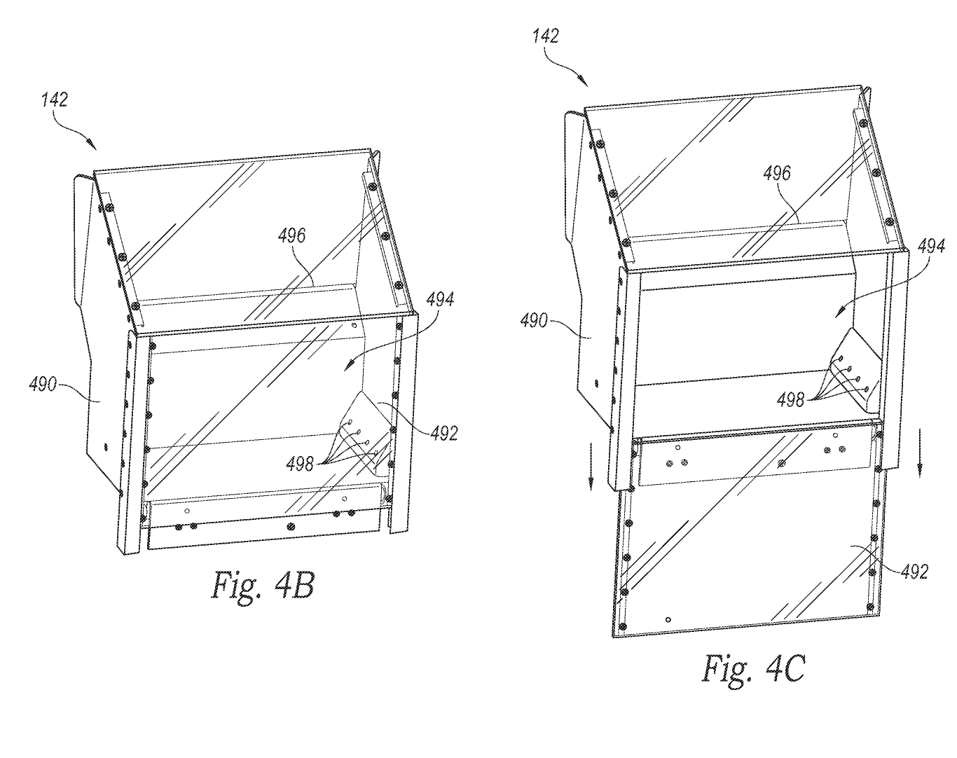

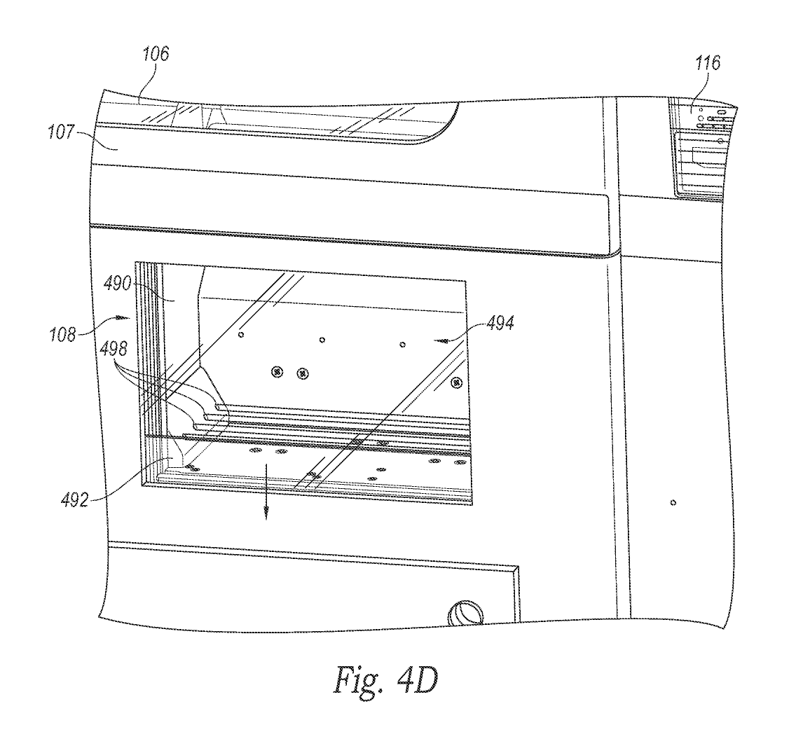

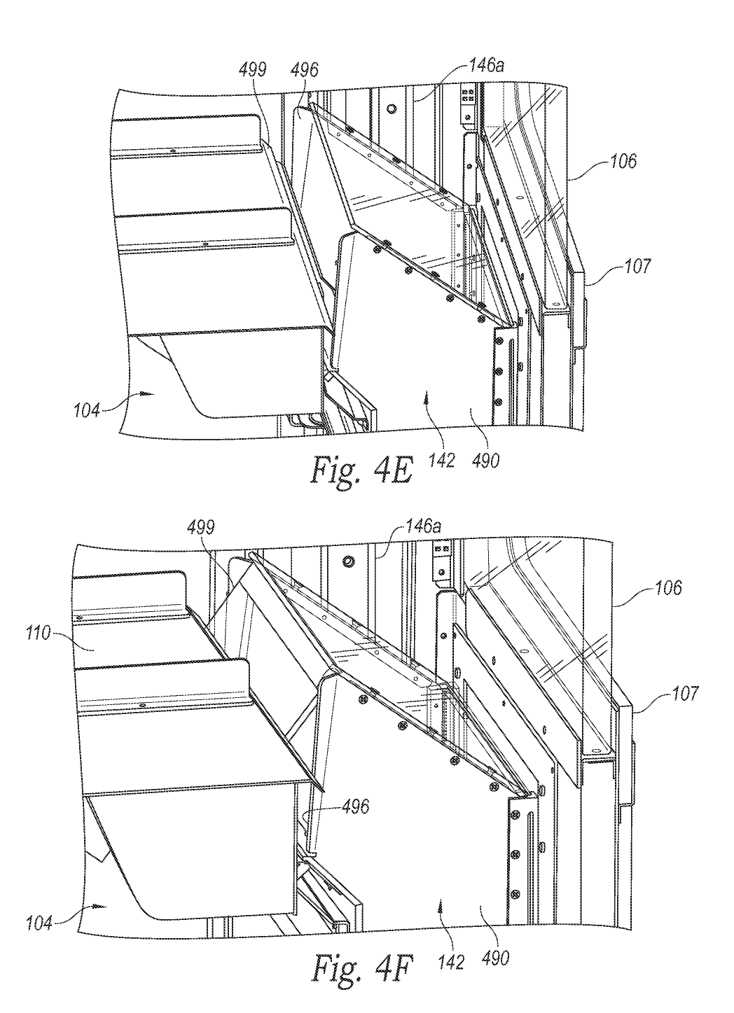

FIGS. 4A-4F illustrate various aspects of the product retrieval system 141 and associated portions of the kiosk 100. As discussed above and as shown in FIG. 4A, the product retrieval system 141 can include the product delivery device 142 operably coupled to the horizontal first rail assembly 144 and the vertical second rail assembly 146 (e.g., extending along the interior of the kiosk door 107). One or more motors 145 can be used to move the product delivery device 142 horizontally along the first rail assembly 144 and move the first rail assembly 144 vertically along the second rail assembly 146 to align the product delivery device 142 with the row and column of the shelf unit 110 (FIG. 1A) corresponding to a selected product.

FIGS. 4B and 4C are enlarged isometric views of the product delivery device 142 in a closed or retrieval configuration and an open or delivery configuration, respectively. The product delivery device 142 can include a body portion 490 and a door or cover 492 that together define a partially enclosed area or space 494 for carrying fresh food products as they are delivered from the shelf units 110 (FIGS. 3A-3D) to the delivery area 108 (FIG. 4D). The product delivery device 142 can also include an opening 496 in communication with the enclosed space 494 and configured to receive products from the shelf units 110 (FIGS. 3A-3D) and direct them into the enclosed space 494. In various embodiments, the default configuration of the product delivery device 142 can be the closed configuration shown in FIG. 4B to provide a suitable carrier or holder for the fresh food products. At the delivery area 108 (FIG. 4D), the product delivery device 142 can move from the closed arrangement (FIG. 4B) to the open arrangement shown in FIG. 4C by sliding or otherwise removing the cover 492 away from at least a portion of the body portion 490 to allow a consumer to access the space 494 through an opening in the kiosk door 107 and retrieve the selected product.

In various aspects of the technology, the product delivery device 142 can include one or more sensors 498 that detect when a product is positioned in the product delivery device 142. In the illustrated embodiment, for example, the sensors 498 include a plurality of LEDs and photo transistors configured to activate when a product is positioned within the enclosed space 494. As shown in FIG. 4D, the LEDs can be illuminated when the photo transistors are activated to indicate the presence of a product and can be turned off when the product is removed from the space 494.

FIGS. 4E and 4F are back isometric views of the product delivery device 142 installed in the kiosk 100 of FIGS. 1A-1D. In the illustrated embodiment, the product delivery device 142 includes a tamper-proof door 499 configured to cover the back opening 496 of the product delivery device 142. For example, the door 499 can be retracted (FIG. 4E) from the opening 496 when the product delivery device 142 is retrieving products from the shelf units 110 and moving them to the dispensing area 108. The door 499 can be extended (FIG. 4F) to close the opening 496 when the product delivery device 142 is in the delivery area 108 and the cover 492 (FIGS. 4A-4C) is opened. The door 499 blocks access to the interior of the refrigerated compartment 104 via the back opening 496 of the product delivery device 142. In various embodiments, the product delivery device 142 can be communicatively coupled the controller 134 (FIG. 1B), which can confirm that the tamper-proof door 499 is in the closed position (FIG. 4F) before opening the cover 492 (FIGS. 4A-4C). Once the product has been retrieved and the cover 492 has been closed, the door 499 can be retracted so that the product delivery device 142 is ready to retrieve another product.

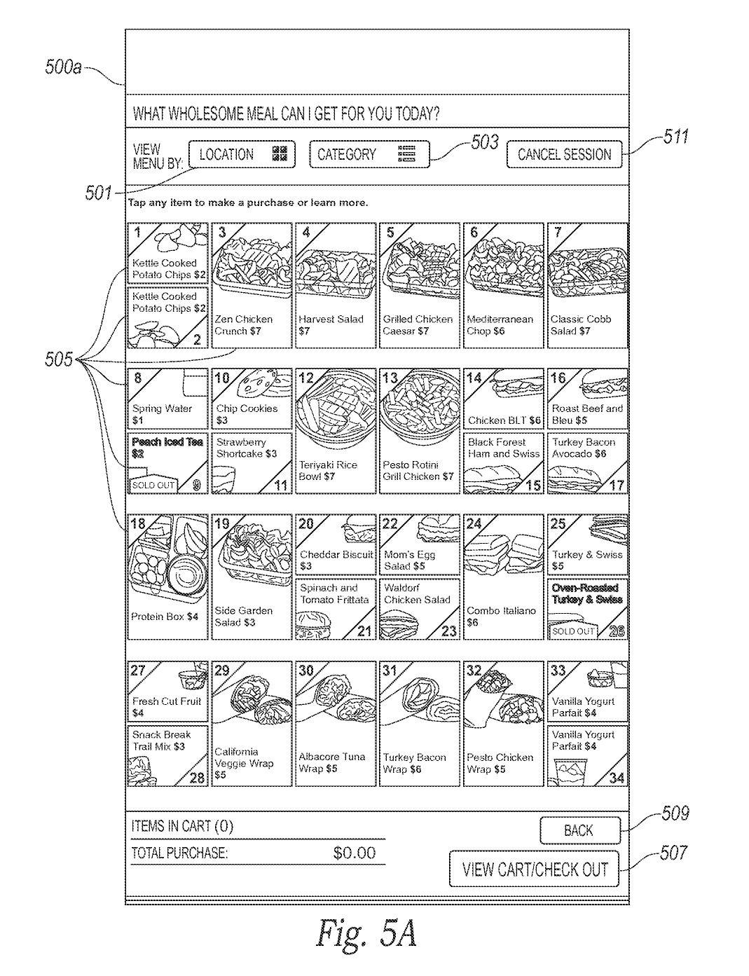

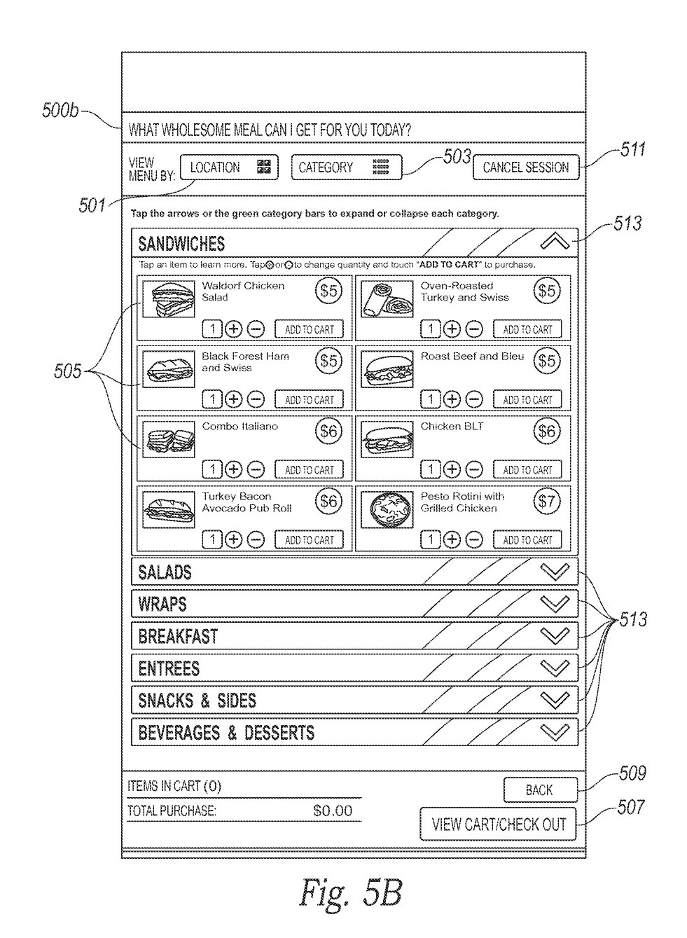

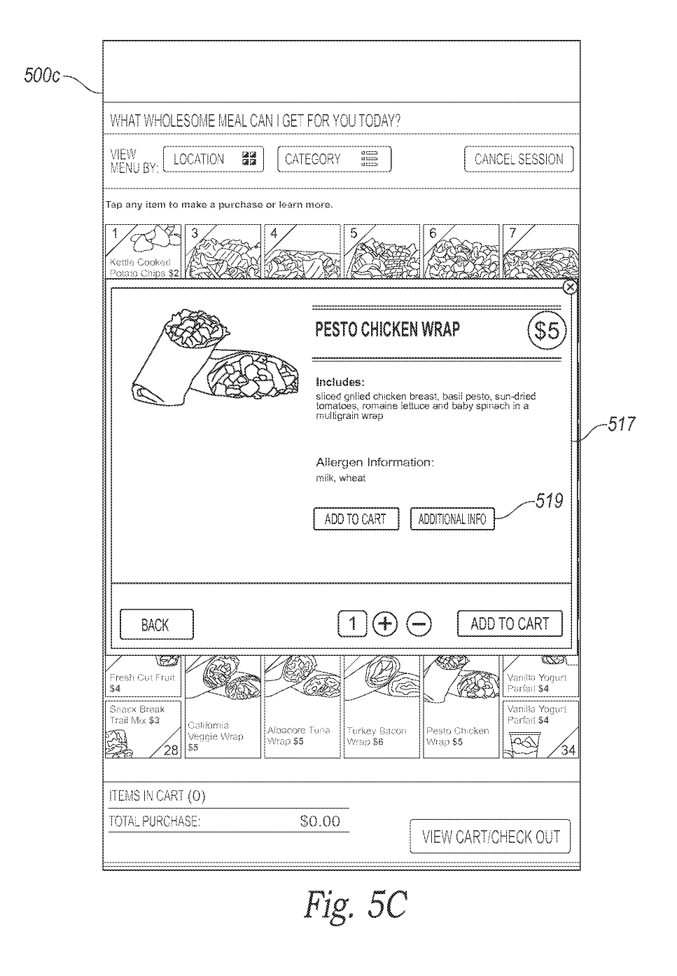

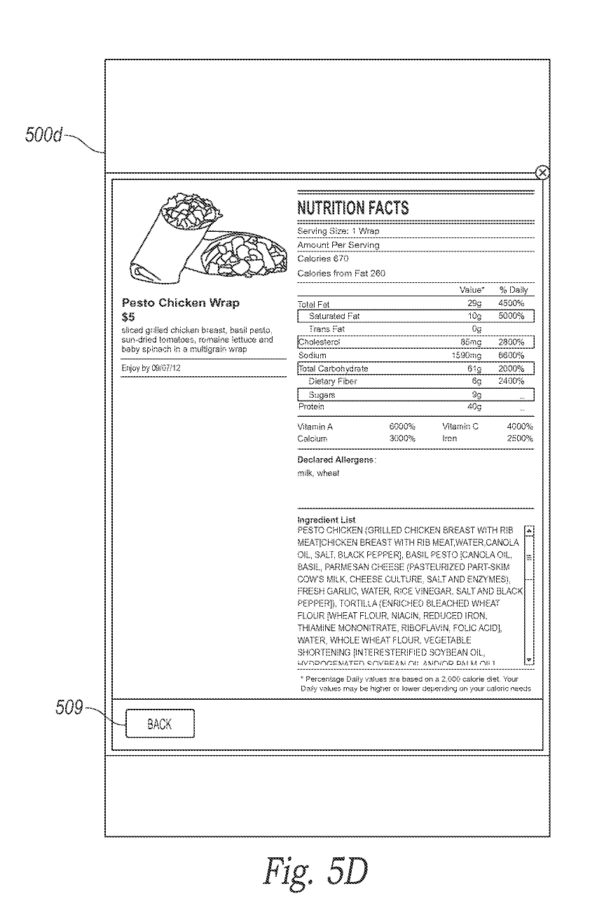

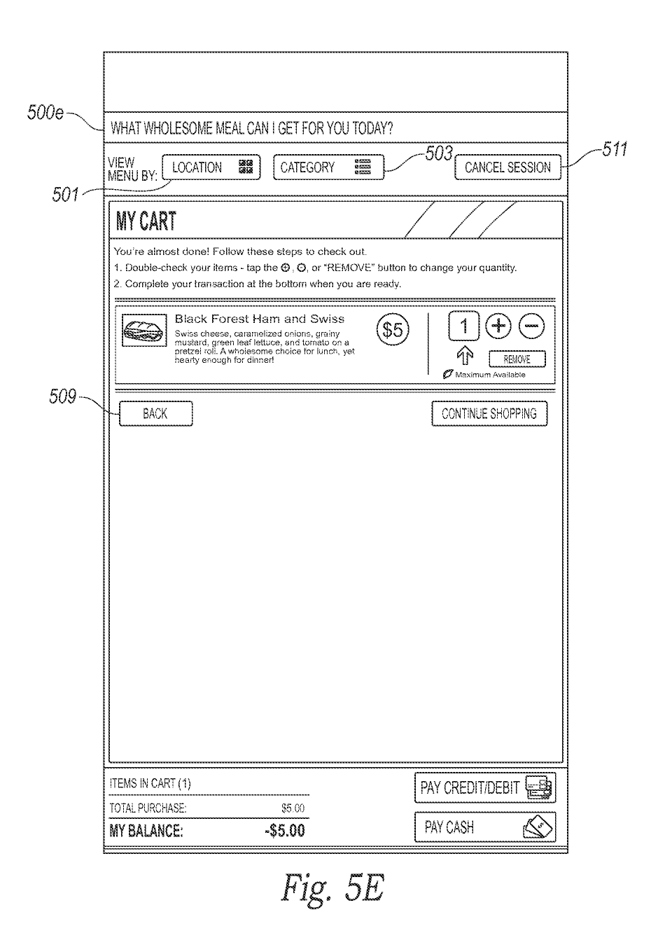

FIGS. 5A-5E illustrate various display pages (identified individually as first through fifth display pages 500a-e, respectively, and referred to collectively as the display pages 500) for advertising and facilitating the purchase of fresh foods from a consumer operated kiosk (e.g., the kiosk 100 described above in FIGS. 1A-4F) in accordance with embodiments of the disclosure. The display pages 500 can be displayed to consumers on a touch screen (e.g., the user interface 112 of FIGS. 1A-1D), monitor, and/or other suitable display for providing information to consumers at the consumer operated kiosk. In various aspects of the technology, the display pages 500 can be accessed on personal devices (e.g., a personal computer, smart phone, tablet computer, etc.) communicatively coupled to the consumer operated kiosk via a network environment described below with respect to FIG. 6.

Referring first to FIG. 5A, the first display page 500a can include various search buttons (e.g., displayed as icons, graphical representations, textual instructions/descriptions, etc.) that allow consumers to select how to view the fresh food items available for purchase at the kiosk. The display page 500a can include, for example, a “Location” button 501 that allows a consumer to view the fresh food items as they are arranged in a refrigerated compartment (e.g., the refrigerated compartment 104 of FIGS. 1A-1D) of the kiosk, and a “Categories” button 503 that allows the consumer to search the food items available for purchase at the kiosk by the type of food (e.g., sandwiches, salads, snacks, beverages, etc.) he or she is interested in purchasing. In the display page 500a shown in FIG. 5A, the consumer has selected the “Location” button 501. Accordingly, the display page 500a includes a plurality of buttons 505 (e.g., displayed as icons, graphical representations, textual menu descriptions, etc.) associated with food items available for sale at the kiosk and arranged in the configuration they are shown in the kiosk (e.g., via a display window in front of the refrigerated compartment). The location search option allows the consumer to easily associate the actual food items in the kiosk with the corresponding icon 505 on the display page 500a. The consumer can simply press or otherwise select the icon 505 associated with the desired food item and the food item will be added to a virtual shopping cart until the consumer goes to the virtual shopping cart page (FIG. 5E), where the consumer can modify the selected item(s) (e.g., modify the quantity selected, remove selected items, etc.) and complete the transaction. As the consumer selects items, the display page 500a can indicate the total purchase price of the selected items.

As further shown in FIG. 5A, the display page 500a can also include a plurality of other buttons that allow the consumer to navigate between display pages. For example, the display page 500a can include a “View Cart/Check Out” button 507 that navigates the display to a virtual shopping cart display page that allows the consumer to view, edit, and/or purchase selected food items. The display page 500a can also include a “Back” button 509 that navigates the display to the previous page, and a “Cancel Session” button 511 that ends the consumer's transaction.

Consumer can also select the “Category” button 503 to navigate the display to the page 500b shown in FIG. 5B. The display page 500b includes a plurality of category buttons 513 associated with different categories of foods available for purchase at the kiosk. When the consumer selects one of the category buttons 513, a drop down menu of the food product icons 515 associated with that category and available for purchase at the kiosk can be displayed to the consumer. The food product icons 515 can include product descriptions, images, prices, and/or other features associated with the food items. As shown in FIG. 5B, the food product icons 515 can also include buttons that allow the consumer to select the quantity of the food item he or she would like and add to the consumer's virtual shopping cart.

As shown in FIG. 5C, when the consumer selects a food product icon (e.g., from the location or category search options), the display page 500c can generate a pop-up window 517 that provides additional details about the selected product and allows the consumer to add the product to his or her virtual shopping cart. The pop-up window 517 can also include an “Additional Information” button 519 that, when selected, navigates the display to a page with further details about the food product. For example, as shown in FIG. 5D, the display can navigate to a page 500d that provides nutritional information to the consumer. In other embodiments, the consumer can access the nutritional information using other suitable navigation paths.

When the consumer selects the “View Cart/Check Out” button 507 (FIGS. 5A and 5B), the display can navigate to the virtual shopping cart page 500e shown in FIG. 5E. This page 500e can include a listing of the selected food items and may allow the consumer to modify his or her selections before making a purchase. The virtual shopping car therefore provides consumers with a more traditional shopping experience in which items can be added or removed from a shopping cart, rather than the single item transaction provided by conventional vending machines. Once satisfied with the selected items, the consumer can tender a selected method of payment and the kiosk can dispense the selected food items from the kiosk to the consumer. In various embodiments, the consumer can add funds to the kiosk (e.g., insert currency into a bill acceptor, swipe a credit, debit, or prepaid card, and/or otherwise provide payment information) at any time during the kiosk transaction. The consumer can, for example, add funds to the kiosk before, during and/or after the consumer has selected the desired food items, and therefore allows the consumer to purchase multiple items in one transaction.

FIG. 6 illustrates a suitable network environment for implementing various aspects of purchasing fresh food items at consumer operated kiosks in accordance with embodiments of the disclosure. One or more consumer operated kiosks 600 can be operatively connected to a server 604 and/or a remote or host computer 612 (e.g., a computer at a central operations facility) via the Internet, a dedicated network, and/or other suitable wired or wireless communications link 602. The kiosks 600 are at least generally similar in structure and function as the kiosk 100 described above. In some embodiments, the kiosks 600 are first networked to one or more host computers (not shown) in a conventional manner that are in turn operatively connected to the communications link 602.

The server 604 can perform many or all of the functions for receiving, routing, and storing of application programs, electronic messages, and other information associated with features of the kiosk network. The server 604 can include a server engine, a content management component, and a database management component. The server engine performs basic processing and operating system level tasks. The content management component handles many of the functions in the embodiments described herein. In other embodiments, these functions can be performed by the kiosks 600 themselves. The database management component of the server 604 includes storage and retrieval tasks with respect to a database 606 coupled to the server 604, queries to the database 606, and storage of data. The database 606 can store at least some of the content associated with the fresh food products available for sale at the kiosks 600 (e.g., food product descriptions, inventory information, sell-by dates, positional data, etc.), shelving arrangements (e.g., planograms, vending instructions, etc.), user account information (e.g., user preferences, past order information, etc.), and other information related to purchasing fresh food products at the kiosks 600. As will be apparent to those skilled in the art, the server 604 can include a single server or a plurality of servers, and the database 606 can include a single database or a plurality of databases. Additionally, the server 604, including the database 606, may employ security measures to inhibit malicious attacks on the system and to preserve the integrity of the messages and data stored therein (e.g., firewall systems, secure socket layers (SSL) password protection schemes, encryption, and the like).

In the illustrated embodiment, the communications link 602 also connects the kiosks 600 to remote personal electronic devices (e.g., personal computers 608, tablets, smart phones, etc.). This allows consumers to use their personal computers, tablets, smart phones, etc., to preview items available for purchase at the kiosks 600, reserve items available for purchase at the kiosks 600, and/or manage user accounts associated with the fresh food kiosk system and stored in the database 606. In certain embodiments, the kiosks 600 can be configured to communicate with personal electronic devices (e.g., smart phones, tablets, etc.) to identify the user, tender payment, etc. via near field communication. As further shown in FIG. 6, the kiosks 600 can be communicatively coupled to financial institutions 610 (e.g., banks) to make purchases at the kiosks 600 with credit and/or debit cards, online payment system (e.g., PayPal, Google Wallet, etc.), and/or other payment systems (e.g., Speedpass). The kiosks 600 can accordingly provide real-time validation of payment information.

A network environment, such as the network environment illustrated in FIG. 6, can connect multiple kiosks 600 positioned in a plurality of publicly accessible areas, such as office buildings, transit terminals, grocery stores, department stores, etc. to the central computer 612. The maintenance of the networked kiosks 600 can then be managed from the back end by the central computer 612. The central computer 612 and/or the server 604, for example, can run routine diagnostic maintenance checks on the kiosks 600 to monitor the temperature within the refrigerated compartments of the kiosks 600, identify mechanical problems (e.g., jams associated with the product delivery systems, malfunctions with a bill or coin acceptor, etc.), and/or glitches in the user interface and display pages. If a problem is detected, a notification can be communicated to the central computer 612 and/or a kiosk technician (e.g., via email) describing the nature of the problem. In certain embodiments, the server 604 and/or the central computer 612 can be configured to identify which technician is responsible for or nearest the kiosk at issue and direct the notification to that technician. This proactive diagnostic monitoring can efficiently and cost-effectively ensure that the food products in the kiosks 600 are stored at proper temperatures and that the kiosks 600 are otherwise operating properly.

The network environment also allows information to be added to the database 606 and/or the central computer 612 and downloaded onto one or more of the kiosks 600. For example, information related to the food items for sale at the kiosks 600 (e.g., nutritional information, menu items, shelf-life, positional data, etc.), advertisements, and/or other types of information may be added and modified at the central computer 612, and downloaded onto one or more of the kiosks 600. Other information, such as operating systems updates, can also be uploaded to the kiosks 600 from the central computer 612 via the communications link 602. In various embodiments, the network environment also allows back end management of promotions via the central computer 612. An operator can, for example, create promotional deals (e.g., discounts on certain products, discounts for a specified period of time, buy two items and get the third for free, etc.) and communicate with one or more of the kiosks 600 via the communications link 602 such that when a consumer purchases a product that falls within the promotion, the kiosk 600 can apply the promotion to the consumer's purchase price. In certain embodiments, discounts can be applied to fresh food items that have been in the kiosk inventory for a predefined time period (e.g., 2 days, 3 days, 1 week, etc.) or are within a predefined time of their sell-by and/or expiration date. Information and advertisements related to promotions can also be downloaded onto the kiosks 600 so that consumers can view the available promotions (e.g., on a user interface or display) before making a purchase. The network environment also allows the central computer 612 to communicate with the kiosk 600 to validate discount codes entered at the kiosks 600 (e.g., via the user interface) and limit the amount of times the discount code is used. In addition, the network environment can provide for user-specific promotions by validating user identification information (e.g., a username and password, a credit card associated with a user account, other login information, etc.) as it is entered at the kiosk 600, and applying the promotion to the user's purchase.

In addition, the network environment allows the inventory of the kiosks 600 to be managed on the back end and in real-time. For example, inventories of the kiosks 600 and/or associated information (e.g., the date the food items were packaged and/or placed in the kiosks 600, when food items are selected for purchase, etc.) can be communicated to the central computer 612 and stored on the remote database 606. In certain embodiments, the initial inventory information can be communicated to the central computer 612 by an operator or maintenance technician, and in other embodiments the kiosks 600 may include sensors and/or other mechanisms that identify the food items as they are placed in the kiosks 600. Sales of the fresh food items at the individual kiosks 600 can be communicated to the central computer 612 via the communications like 602. The central computer 612 can use this inventory information to provide real-time inventory management of the kiosks 600, which can be especially useful with respect to the fresh food kiosk system to track the freshness and the product mix of the kiosk inventories. The inventory information can also be used for inventory analytics that allow the kiosk operator to predicatively plan distribution schedules of fresh food products to the kiosks 600, food production schedules (e.g., based on the movement of the kiosk inventory), ingredient ordering schedules for food production, and/or other predictive planning associated with the kiosk inventory. In various embodiments, the network environment also allows user account information to be stored in the database 606 and shared among the kiosks 600 in the network, and track user activity at the networked kiosks 600. In other embodiments, at least a portion of the information stored on the remote database 606 (e.g., inventory information, vending instructions, etc.) can also or alternatively be stored locally at the kiosks 600 (e.g., on a local database).

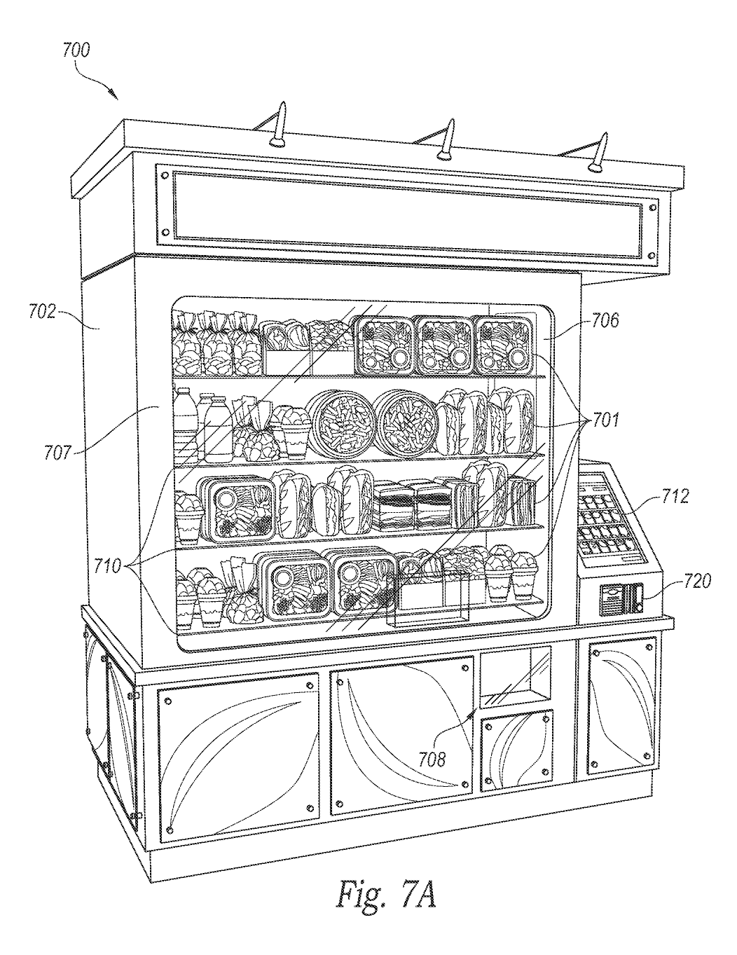

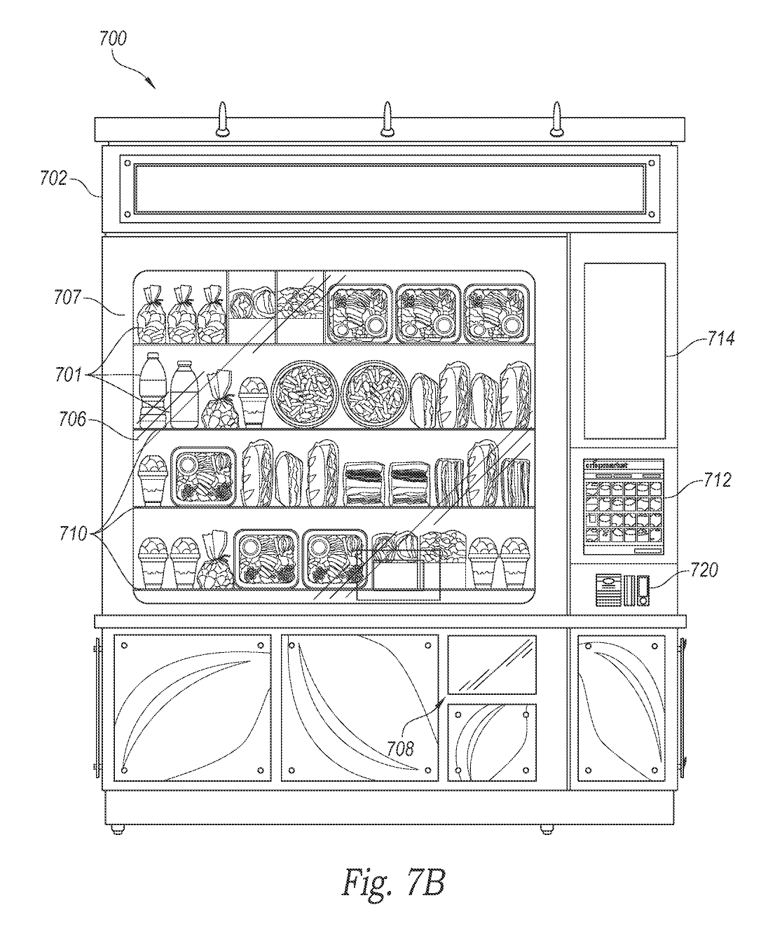

FIGS. 7A and 7B are isometric and front views of a consumer operated kiosk 700 (“kiosk 700”) for purchasing fresh foods in accordance with other embodiments of the disclosure. The kiosk 700 includes many features that are at least generally similar in structure and function as those of the kiosk 100 described with respect to FIGS. 1A-4F. The kiosk 700, for example, includes a housing 702 with a refrigerated compartment 704, a display window 706 in front of the refrigerated compartment 704, and a dispensing area 708 in communication with the refrigerated compartment 704. The refrigerated compartment 704 can store a plurality of beverages, foods, and/or other fresh food items 701 on shelf units 710 within the compartment 704. The kiosk 700 can further include a user interface 712 configured to operationally interface with users and a display 714 that can provide additional information to the user.

From the foregoing, it will be appreciated that specific embodiments of the disclosure have been described herein for purposes of illustration, but that various modifications may be made without deviating from the spirit and scope of the invention. Aspects of the invention described in the context of particular embodiments may be combined or eliminated in other embodiments. Further, while advantages associated with certain embodiments of the invention have been described in the context of those embodiments, other embodiments may also exhibit such advantages, and no embodiment need necessarily exhibit such advantages to fall within the scope of the invention. Accordingly, the invention is not limited, except as by the appended claims.

I/We claim:

1. A consumer operated kiosk for purchasing fresh foods, the consumer operated kiosk comprising:
a housing having a temperature controlled compartment configured to store an inventory of fresh foods items;
a dispensing area in communication with the temperature controlled compartment;
a user interface configured to receive user instructions corresponding to selected fresh food items;
a product retrieval system within the temperature controlled compartment, wherein the product retrieval system is configured to move the selected fresh food items from the refrigerated compartment to the dispensing area;
means for receiving funds in payment for the selected fresh food items; and
a communications facility configured to—
send transaction information related to the selected fresh food items to a remote computer to update inventory information stored in a remote database, wherein the inventory information is associated with the consumer operated kiosk; and
communicate with the remote computer to monitor ages of the fresh food items in the inventory.

2. The consumer operated kiosk of claim 1 wherein:
the communications facility is configured to communicate with the remote computer to download menu items corresponding to the fresh food items available for purchase at the consumer operated kiosk; and
the user interface is configured to display the menu items.

3. The consumer operated kiosk of claim 1, further comprising:
a display window positioned at a front side of the temperature controlled compartment,
wherein the user interface is configured to display a plurality of buttons corresponding to the fresh food items available for purchase at the consumer operated kiosk, and wherein the buttons are arranged on the user interface in a layout corresponding to that of the fresh food items in the display window.

4. The consumer operated kiosk of claim 1, further comprising a shelving assembly in the temperature controlled compartment, wherein the shelving assembly includes a plurality of shelf units attached to a support member, wherein the shelving assembly is movable between a loaded position and a loading position, the shelf units being positioned within the temperature controlled compartment when the shelving assembly is in the loaded position and a at least partially outside the temperature controlled compartment when the shelving assembly is in the loading position.

5. The consumer operated kiosk of claim 1, further comprising:
a shelving assembly including a support member, a plurality of shelf units removably attached to the support member, and a plurality sensors configured to detect positions of the shelf units relative to the support member; and
a controller communicatively coupled to the product retrieval system and to the sensors of the shelving assembly, wherein the controller is configured to selectively communicate positional information of the individual shelf units to the product retrieval system to move the product retrieval system to the shelf units corresponding to selected fresh food items.

6. The consumer operated kiosk of claim 5 wherein the communications facility is configured to:
communicate with the remote computer to retrieve a shelving layout corresponding to an arrangement of the shelf units within the temperature controlled compartment; and
communicate with the remote computer to indicate when any shelf units are not arranged in accordance with the shelving layout.

7. The consumer operated kiosk of claim 1, further comprising a plurality of shelf units in the temperature controlled compartment, wherein the individual shelf units include:
a base portion with a generally planar support surface; and
a plurality of adjustable side supports extending from the base portion, wherein the adjustable side supports are configured to move inward toward the support surface and outward away from the support surface to accommodate fresh food items with different dimensions.

8. The consumer operated kiosk of claim 1 further comprising a plurality of shelf units in the temperature controlled compartment, wherein the individual shelf units include:
a base portion with a generally planar support surface; and
a driving mechanism configured to move the fresh food items on the shelf unit forward along the support surface to deliver selected fresh food items to the product retrieval system.

9. The consumer operated kiosk of claim 8 wherein each shelf unit includes an end portion and a sensor at the end portion, wherein the sensor is configured to detect when the product retrieval system is aligned with the shelf unit, wherein the driving mechanism is configured to move the fresh food items forward along the support surface in response to the detection of the aligned product retrieval system, and wherein the sensor is configured to detect when the fresh food items move from the shelf unit to the product retrieval system.

10. The consumer operated kiosk of claim 1, further comprising:
a plurality of shelf units arranged according to a shelving layout in the temperature controlled compartment; and
wherein the product retrieval system comprises—
a rail assembly; and
a product delivery device configured to move along the rail assembly to align with the shelf unit corresponding to each selected fresh food item, and move along the rail assembly from the shelf unit of the selected fresh food item to the dispensing area after receiving the selected fresh food item from the shelf unit.

11. The consumer operated kiosk of claim 1 wherein the product retrieval system includes a product delivery device having a body portion, a cover, and a sensor, wherein the body portion and the cover define a partially enclosed area for receiving fresh food items from within the temperature controlled compartment, and wherein the sensor is configured to indicate when fresh food items are in the enclosed area.

12. The consumer operated kiosk of claim 1 wherein:
the user interface is configured to display menu items corresponding the fresh food items available for purchase at the consumer operated kiosk; and
the communications facility is configured to receive instructions from the remote computer to remove menu items from the user interface when the corresponding fresh food items are past a predetermined age.

13. The consumer operated kiosk of claim 1 wherein:
the user interface is configured to display menu items corresponding the fresh food items available for purchase at the consumer operated kiosk; and
the communications facility is configured to receive instructions from the remote computer to display sold out messages associated with the menu items when the corresponding fresh food items are no longer in the inventory.

14. The consumer operated kiosk of claim 1 wherein the communications facility is configured to receive instructions from the remote computer to apply price discounts to fresh food items within a predetermined time of a sell-by date.

15. The consumer operated kiosk of claim 1 wherein:
the communications facility is configured to communicate with the remote computer to download position data associated with each fresh food item in the temperature controlled compartment and vending instructions corresponding to the position data of each fresh food item; and
the product retrieval system is configured to receive the vending instructions to move the selected fresh food items from the temperature controlled compartment to the dispensing area.

16. An at least partially automated method of purchasing fresh foods, the method comprising:
providing a consumer operated kiosk having a refrigerated compartment, wherein the refrigerated compartment includes an inventory of fresh food items available for purchase at the consumer operated kiosk;
displaying a plurality of menu items on a user interface of the consumer operated kiosk, wherein the menu items correspond to the fresh food items available for purchase at the consumer operated kiosk;
receiving a user selection corresponding to at least one of the menu items;
receiving funds from a user to pay for the selected menu items;
moving the fresh food items corresponding to the selected menu items from the refrigerated compartment to a delivery area of the consumer operated kiosk for retrieval by the user;
transmitting changes to the inventory of fresh food items to a remote computer, wherein the remote computer is configured to update inventory information associated with the consumer operated kiosk and store the inventory information on a remote database; and
monitoring ages of the fresh food products in the consumer operated kiosk.

17. The method of claim 16, further comprising communicating with the remote computer to download menu items at the consumer operated kiosk in response to new fresh food items being added to the inventory information.

18. The method of claim 16, further comprising:
detecting when a particular fresh food item in the inventory is sold out at the consumer operated kiosk; and
removing the menu item associated with the particular fresh food item from the displayed menu items.

19. The method of claim 16, further comprising receiving instructions from the remote computer to remove the menu item associated with a particular fresh food item that is past an associated sell-by date.

20. The method of claim 16, further comprising receiving instructions from the remote computer to apply price discounts to fresh food items that have been in the consumer operated kiosk longer than a predetermined time period.

21. The method of claim 16, further comprising transmitting transaction information from the consumer operated kiosk to the remote computer, wherein the transaction information includes information related to the fresh food items purchased during individual transactions at the consumer operated kiosk, times of the individual transactions, and/or time elapsed during the individual transactions.

22. The method of 16, further comprising:
measuring temperature within the refrigerated compartment;
identifying when the temperature within the refrigerated compartment falls outside a predetermined threshold temperature range for a predetermined time; and
communicating with the remote computer to report temperature measurements that fall outside the predetermined temperature range for the predetermined period.

23. The method of 22, further comprising disabling sale of the fresh food items at the consumer operated kiosk in response to the detection of temperatures outside the predetermined temperature range.

24. The method of claim 16, further comprising:
receiving user identification information at the consumer operated kiosk, wherein the user identification information is associated with order information stored in the remote database, and wherein the order information relates to at least one fresh food item pre-selected by the user from a website associated with the consumer operated kiosk; and
retrieving the order information associated with the user identification information from the remote database; and
moving the pre-selected fresh food item from the refrigerated compartment to a delivery area of the consumer operated kiosk for retrieval by the user.

25. The method of claim 16 wherein displaying the plurality of menu items at the consumer operated kiosk comprises providing a display page with the menu items arranged in a layout corresponding to that of the fresh food items in the refrigerated compartment.

26. The method of claim 16 wherein receiving funds from the user comprises receiving payment for all the selected menu items to pay for the selected menu items together in a single payment transaction.

27. The method of claim 16, further comprising:
storing user selections of the menu items in a virtual shopping cart associated with a user transaction;
displaying the virtual shopping cart to the user via a user interface; and
receiving user instructions to edit the menu items in the virtual shopping cart.

28. The method of 16, further comprising receiving instructions from the remote computer to disable sale of specified fresh food items at the consumer operated kiosk.

29. The method of claim 16, further comprising:
communicating with the remote computer to download position data associated with each fresh food item in the refrigerated compartment and vending instructions corresponding to the position data; and
wherein moving the fresh food items corresponding to the selected menu items from the refrigerated compartment to a delivery area includes moving a product delivery device in accordance with the vending instructions to deliver the selected menu items to the delivery area.

30. The method of claim 16 wherein displaying the plurality of menu items on the user interface further comprises displaying ingredient listings and/or nutritional information associated with each fresh food item.

31. The method of claim 16, further comprising:
storing the inventory information on a local database at the consumer operated kiosk; and
updating the inventory information on the local database to reflect changes in the inventory of fresh food items at the consumer operated kiosk.

32. An at least partially automated method of selling fresh food items, the method comprising:
storing inventory information associated with a network of consumer operated kiosks on a remote database, wherein the inventory information includes a listing of fresh food items available for purchase at the individual consumer operated kiosks, and wherein the individual consumer operated kiosks include temperature controlled compartments for housing fresh food items;
receiving transaction information from the consumer operated kiosks at a remote computer, wherein the transaction information relates to fresh food items purchased at one of the consumer operated kiosks in the network;
communicating with the remote database to update the inventory information in response to receipt of the transaction information;
sending instructions from the remote computer to the consumer operated kiosks to download menu items associated with new fresh food items added to the inventory information and remove menu items corresponding to fresh food items removed from the inventory information; and
indicating to an operator when each consumer operated kiosk needs restocking.

33. The method of claim 32, further comprising:
communicating a shelving layout from the remote computer to at least one of the consumer operated kiosks, wherein the shelving layout corresponds to an arrangement of shelving units in the temperature controlled compartment of the consumer operated kiosk;
receiving positional information of the individual shelf units within the refrigerated compartment at the remote computer; and
indicating any deviations from the shelving layout to the remote computer.

34. The method of claim 32, further comprising:
receiving a notification at the remote computer when temperature measurements of a particular consumer operated kiosk in the network are outside of a predetermined temperature range; and
sending instructions to the particular consumer operated kiosk to disable sales of fresh food items when the temperature measurements are outside the predetermined temperature range for a predetermined time period.

35. The method of claim 32 wherein the inventory information further includes sell-by dates associated with the fresh food items, and wherein the method further comprises alerting the operator via the remote computer when fresh food items are nearing corresponding sell-by dates.

36. The method of claim 32, further comprising:
monitoring ages of the fresh food items of the individual consumer operated kiosks at the remote computer; and
sending instructions to the consumer operated kiosks to remove the menu items associated with the fresh food items that are beyond a predetermined age.

37. The method of claim 32, further comprising:
monitoring ages of the fresh food items of the individual consumer operated kiosks at the remote computer; and
sending instructions to the consumer operated kiosks to apply price discounts to the fresh food items that are near a predetermined age.

38. The method of claim 32, further comprising communicating position data to the individual consumer operated kiosks, wherein the position data corresponds to a position each fresh food item in the temperature controlled compartment.
